(19) United States
(12) Patent Application Publication
(10) Pub. No.: US 2019/0213616 A1
(43) Pub. Date: Jul. 11, 2019

(54) Shopper Traffic Flow Spatial Analytics Based on Indoor Positioning Data

(71) Applicant: POINT INSIDE, INC., Bellevue, WA (US)

(72) Inventors: Geary Eppley, Bellevue, WA (US); Josh Marti, Bellevue, WA (US); Jonathan Alan Croy, Bellevue, WA (US); James Hindman, Bellevue, WA (US); Brandon Ferguson, Bellevue, WA (US); Jared Tolman, Bellevue, WA (US)

(73) Assignee: POINT INSIDE, INC., Bellevue, WA (US)

(21) Appl. No.: 15/869,018

(22) Filed: Jan. 11, 2018

(51) Int. Cl. G06Q 30/02; G06F 17/30; H04W 4/02

(52) U.S. Cl. CPC G06Q 30/0205; G06Q 20/202; H04W 4/02; G06F 17/30241

(57) ABSTRACT

Indoor positioning information provide location detail records (LDRs), which are visualized on a map to show a shopper's path through a given store. However, LDR often provides an incomplete picture of a shopper's true journey through a store. Thus, gaps in LDR data are augmented, or filled in, using a routing engine based on point of sale (POS) transaction data to connect the last known position from the first event to first known position from second event, and so on for all the LDR records. If the last LDR doesn't end at the checkout or exit, a final route to a checkout stand used is appended to the last LDR sequence signifying the end of the shopping journey. Dwells are determined based on position data from the LDRs of selected shoppers over a selected period of time. There might not be POS data, but if there is, the LDR data is augmented with positions as determined by the location of each product purchased—filling in all gaps with a routing service.

### BACKGROUND OF THE INVENTION

### 1. Field of the Invention

The invention relates to analytical systems and methods for extracting shopper traffic flow, and impressions of items located in a retail store, based on indoor positioning data and the physical location of items within the retail store.

### 2. Background of Related Art

The ‘location’ of an item for sale relates to the physical place within the store or venue where the item is located or displayed for purchase. ‘Items’ as used herein may refer to individual items in a product catalog, or can alternatively refer to clusters of items having at least one common attribute. Point of sale (POS) transactional data as used herein is presumed to include an identity of an item or items purchased, an identity of the particular checkout stand used for that purchase, and various other POS transactional data such as time purchased, date purchased. Location may also relate to a subset area within the store, for example, a shelf-location, a location of a clothing rack or fixture, or just a polygon shape area within a selling-department where merchandise can be placed for sale. In a general sense, ‘location’ is defined as a shape of area in the store that is smaller than a department. In disclosed embodiments the location may be a geographic area within the store of 3 feet by 3 feet. Apart from good precision, coverage (meaning how many items can be assigned with enough confidence) is also crucial for product location assignment.

Location-type analytics, in theory, can provide more detailed customer interaction information. Customer-carried location-type analytics on smartphones and other mobile devices was first developed based on the presence of an indoor location technology, and the ability to use shopper location data to tabulate the same data. However, in reality the number of users (shoppers who had a specific app installed, operating and authorized to allow for location monitoring-and used the app while shopping in a given store) is in practice rather low, and the resulting data with these type systems tends to be biased toward the habits of technically proficient users who would be using such an app. Nevertheless, for the data that an indoor positioning system does provide, the information about the location of the shopper and the time that they were there is quite accurate. The problem is that it turns out that actual user data from such active consumer devices typically contains gaps created, e.g., by the user intermittently engaging the with app (e.g., in a search for nails, checking their shopping list, looking for a coupon) and then closing it and putting it in their pocket for the remainder of a given shopping visit. Thus, while in theory customer-carried analytics systems would provide more detailed customer interaction information, in reality it suffers from intermittent use by customers, and thus the signals generated contain gaps resulting in limited functionality for use in conventional analytical systems.

In any event, with knowledge of the location (and thus the pathway) that a shopper took through a store, the accurate knowledge of physical location for all items in the store is important. Complete and accurate location information provides the basis for accurate merchandizing analytics so that items might be placed—or removed entirely—in a way that maximizes profitability of the store.

Given the location of items within a store, analytics systems and methods, fine grain location analytics systems and methods, and A/B testing can improve the square-foot based profitability of a given store. But such analytics are then reliant upon accurate information of a route taken by shoppers as they journey through a given store. Analytics systems and methods all can benefit greatly from a system and method that determines more detailed customer interaction information.

There is a need for improved analytical systems, for passive analytical systems that do not require active acceptance and adoption by customers, to enable improved efficiency and profitability of any given store.

### SUMMARY OF THE INVENTION

In accordance with one aspect of the present invention, a method of generating item location based shopper impressions based on indoor positioning data of a shopper's location in a store comprises associating a physical location, within a given store, to a plurality of items available at the given store. A plurality of sets of location detail records (LDRs) are obtained, each relating to one of a plurality of shoppers at the given store within a given time frame. The plurality of sets of location detail records (LDRs) are filtered to those filtered LDR sets including at least one LDR associated with an item available at the given store having a given attribute. A pathway of physical journey is plotted through the given store as indicated by a selected one of the filtered LDR set representing one shopper, and a route calculated between an item purchased by the one shopper but not included in the selected filtered LDR set, and a nearest node on the pathway of physical journey, is appended to the pathway of physical journey.

In accordance with another aspect of the invention, a method of generating item location based shopper dwell based on indoor positioning data of a shopper's location in a store comprises associating a physical location, within a given store, to a plurality of items available at the given store. A plurality of sets of location detail records (LDRs) are obtained, each relating to one of a plurality of shoppers at the given store within a given time frame. The plurality of sets of location detail records (LDRs) are filtered into a logical row or column of filtered LDR sets including at least one LDR associated with an item available at the given store having a given attribute. A plurality of dwell locations associated with each of the filtered LDR sets are determined, and are output corresponding to an aggregate of a plurality of shoppers associated with the filtered LDR sets on their physical travel through the given store.

### BRIEF DESCRIPTION OF THE DRAWINGS

Features and advantages of the present invention will become apparent to those skilled in the art from the following description with reference to the drawings, in which:

FIG. 1 illustrates an exemplary product location analytics system including a product location analytics server and a product location database, in accordance with the principles of the present invention.

FIG. 2 is a functional block diagram of an exemplary product location analytics server computing device and relevant data structures and/or components thereof.

FIG. 3 is a functional block diagram of an exemplary product location database, in accordance with the principles of the present invention.

FIGS. 4A and 4B show near real-time user locations in a map view of given shoppers in a given store, in an example of the present invention.

FIGS. 5A and 5B show a map view of a given shopper's location entering a given store in near real-time.

FIGS. 6A and 6B show a map view relevant to a first location detail record (LDR) showing the given shopper's path between their entrance into the given store to the location of the first location detail record (LDR).

FIGS. 7A and 7B show a map view relevant to the next location detail record (LDR) as the given shopper enters a search for “Kids Learning” into the app they are running on their smartphone that includes a location engine (LE).

FIGS. 8A and 8B show a map view relevant to the next location detail record (LDR) as the given shopper selects “Fisher Price Think & Learn “Code-A-Pillar”.

FIGS. 9A and 9B show a map view relevant to the next location detail record (LDR) as the given shopper receives a recommendation for jeans on sale.

FIGS. 10A and 10B show a map view relevant to the next location detail record (LDR) as the given shopper passes through the Cosmetics department in the store and receives a deal recommendation for body butter.

FIGS. 11A and 11B show a map view relevant to the next location detail record (LDR) as the given shopper reaches the Toy department and locates the toy that the given shopper selected in their search.

FIGS. 12A and 12B show a map view relevant to the next location detail record (LDR) as the given shopper doubles back to the previously recommended body butter in the Bath & Beauty department.

FIGS. 13A and 13B show a map view relevant to the next location detail record (LDR) as the given shopper also doubles back to the other previously recommended item, jeans on sale.

FIGS. 14A and 14B show a map view relevant to the last location detail record (LDR) of the given shopper at a checkout lane where they purchase the three items.

FIG. 15 shows input of point of sale (POS) transaction data to a product analytics server in accordance with the principles of the present invention.

FIGS. 16A and 16B show a map view of a given shopper's journey through a store, but missing location detail records relating to a purchase of “ITEM 1” that is indicated in a point of sale (POS) transaction receipt.

FIG. 17 shows an exemplary output function of the location analytics server wherein a “heat map” is generated by appropriate algorithms to provide location of all items in the relevant store, in accordance with the principles of the present invention.

FIG. 18 shows an example of “impressions” for “3M” branded products, e.g., within a period of the past 30 days, depicted as a “heat map”, for a given store, generated by the location analytics server, in accordance with the principles of the present invention.

FIG. 19 shows an example of “dwells” for “3M” branded products, e.g., within a period of the past 30 days, depicted as a “heat map”, for a given store.

FIG. 20 shows an example of “dwells” for “Scotts” branded products, e.g., within a period of the past 30 days, depicted as a “heat map”, for a given store.

FIG. 21 shows an example of “impressions” for “Whirlpool” branded products, e.g., within a period of the past 30 days, depicted as a “heat map”, for a given store.

FIGS. 22A and 22B show a heat map view of an aggregate of shoppers over a selected period of time through the given store.

FIGS. 23A and 23B show a heat map and exemplary impressions statistics for an aggregate of shoppers at a given store over a selected period of time.

FIGS. 24A and 24B show a heat map of a brand affinity analysis, in accordance with the principles of the present invention.

FIGS. 25A and 25B show a heat map and exemplary dwell statistics for aggregated shopper activity at a given store within a selected period of time.

### DETAILED DESCRIPTION OF ILLUSTRATIVE EMBODIMENTS

In accordance with the present invention, indoor positioning information provide location detail records (LDRs), which are visualized on a map to show a shopper's path through a given store. However, LDR often provides an incomplete picture of a shopper's true journey through a store. Thus, gaps in LDR data are augmented, or filled in, using a routing engine based on point of sale (POS) transaction data to connect the last known position from the first event to first known position from second event, and so on for all the LDR records. If the last LDR doesn't end at the checkout or exit, a final route to a checkout stand used is appended to the last LDR sequence signifying the end of the shopping journey. Dwells are determined based on position data from the LDRs of selected shoppers over a selected period of time. There might not be POS data, but if there is, the LDR data is augmented with positions as determined by the location of each product purchased—filling in all gaps with a routing service.

To enable location-based analytics, a viable location assignment system is required which is capable of assigning a location to all items available for purchase in a store. In larger retail chain stores this can amount to many tens of thousands, or even over 100,000 items. A location assignment system determines location information within a given store for all items or products in a retailer's catalog. In general, items in the store are misplaced, moved, re-arranged, or simply out of stock, and over time their locations in the store can become unknown. The location-based analytics provided herein work best with a location system capable of determining a physical location of 100% of products in a retail system—even when such products tend to move around a store from day to day.

Suitable location assignment systems have been disclosed in other applications co-owned with the present invention. For instance, one suitable location assignment system based on point of sale (POS) transaction data is disclosed in U.S. application Ser. No. 15/833,402 entitled “Transaction Based Location Assignment System and Method”, the entirety of which is expressly incorporated herein by reference.

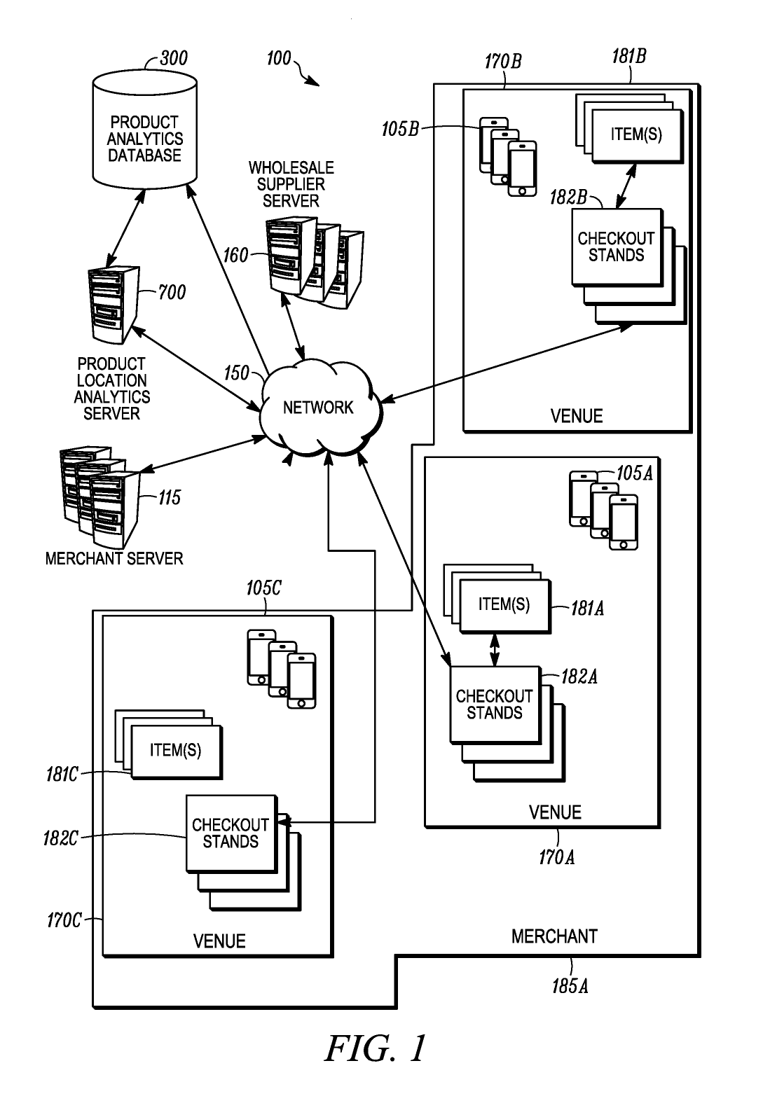

FIG. 1 illustrates an exemplary product location analytics system including a product analytics server 700 and a product analytics database 300, in accordance with the principles of the present invention.

In particular, as shown in FIG. 1, the product analytics server 700 may be in communication with a merchant 185 including a single venue 170A, or that includes a plurality of separate venues 170A, 170B, 170C. The venues 170A, 170B, 170C each include a plurality of point-of-sale terminal checkout stands 182A, 182B, 182C that each provide point of sale (POS) transaction information relating to a respective catalog of items 181A, 1816, 181C available in the respective store (venue) 170A, 1706, 170C.

Location detail records (LDR) are logged by a location engine (LE) within mobile devices 105A, 1056, 105C when a suitable third party app program is operating within, and provided for access by the product analytics server 700.

Point of sale transaction information may be obtained from a network element other than directly from POS terminal checkout stands 182A, 1826, 182C, e.g., from a store server, within the principles of the present invention. Each ‘checkout stand’ as referred to herein may be either a single POS terminal (cash-register) or a cluster of two, three or four (or more) POS terminals arranged in very close proximity to each other. Location of the checkout stand can be temporary or permanent so as to accommodate a mobile environment, e.g., use of a mobile device such as a mobile phone or smart phone for checkout, or use of a mobile handheld scanner device provided by the retailer for use within the store.

Mobile devices 105A, 1056, 105C may be used as mobile payment devices by customers at the POS checkout stands 182A, 1826, 182C to complete sale transactions of particular items 181C. Such transactions are included within POS transaction data utilized by a product location analytics server 700 of the present invention. Of course, other traditional payment methods may alternatively be used, e.g., a credit card, debit card, cash, etc. Each POS checkout stand 182A within a given venue 170A preferably provides transactional receipt data for each purchase made to an appropriate merchant server 115 via a network 150. In accordance with the invention, the transactional receipt data is either directly or indirectly forwarded to or accessible by the product location analytics server 700, in accordance with the principles of the present invention.

The product analytics server 700 or the merchant server 115 may search the POS transaction receipt data as desired, e.g., to obtain point of sale (POS) transaction receipt data on a given day/time at a given store. The POS transaction data includes items purchased, and a date/time purchased. The POS transaction data may also include a price paid for the items purchased. In accordance with the principles of the present invention, the point of sale (POS) transaction data, if available, may be used to provide a location within the store of items as shown and described in co-owned U.S. patent application Ser. No. 15/833,402 entitled “Transaction Based Location Assignment”, filed Dec. 6, 2017, the entirety of which is expressly incorporated herein by reference.

RFID or other location tracker or beacon devices may be associated with some of the retailer's catalog items 181A, 181B, 181C as a source of location data.

FIG. 1 depicts a merchant 185 having a plurality of venues 170A, 1706, 170C thus disclosing that the present invention relates equally to product location analytics for item catalogs relating to larger retail merchants having a plurality of venues 170A, 1706, 170C. In disclosed embodiments, each venue 170A, 1706, 170C has its own layout, its own location detail records (LDRs), its own point of sale (POS) transaction data, its own uniquely identified checkout stands, etc. Of course, it is within the scope of the invention for a retail system having a number of stores with nearly identical floor plans and nearly identical planograms to utilize POS transaction data from any of their similar stores as input to the location analytics system for any other of their similar stores.

CAD floor plan(s) in some embodiments may divide the venues 170A, 170B in the y-coordinate by aisles, rows and the like, and may be associated with a size of the aisle, row, or the like (such as, for example, 7′-7″). The CAD floor plan(s) of the venues 170A, 1706 in these embodiments are divided in the x-coordinate by bay, section, shelving units, and the like. Some sections may occupy an entire row (a y-coordinate unit), or a portion of a row (an x-coordinate within a y-coordinate unit). The CAD floor plan(s) of the venues 170A, 1706 may further comprise z-values for layers of shelves, shelf sections, or the like, and/or such z values may be represented by additional layers in CAD floor plan(s). Components of the CAD floor plan(s) which describe the occupation of space such as rectangular units, areas, points, anchor points (which may indicate the starting point for measuring a distance), dimensions, identification of aisles, sections or bays and the like shall be referred to herein as “spatial units.” The spatial units in the CAD floor plan(s) may correspond to standard units, such as a 2′ or 4′ lengths, 2′ by 4′ rectangles, and the like or may have non-standard defined dimensions.

Item unique identifier(s) such as a SKU, UPC, or product name or number, a barcode or the like, are preferably used to identify items.

An error radius or other type perimeter for an assigned location of any item may be set, and used to identify an uncertainty in the location assigned to an item, preferably relative to the determined location (or relative to a center of a determined location). The error radius may be a circular radius, a non-circular area such as a rectangular area within an aisle (as may fit within a circular radius, factoring in the shape of the venue and utilization of spatial units such as aisles), or the like.

Blocks in FIG. 1 enclosing the merchant 185 with venues 170A, 170B, 170C are logical blocks, not necessarily indicating physical boundaries. Venues 170A, 170B, 170C may be buildings, such as stores comprising merchandise items for sale, at multiple distinct geographic locations. POS terminal checkout stands 182A, 182B, 182C may be, for example, cash registers, checkout stands, clusters of the same, or equivalent devices capable of facilitating the completion of a transaction to purchase an item. Moreover, while the disclosed embodiments relate to POS terminal checkout stands 182A, 182B, 182C being at fixed locations within the store, the present invention relates equally to the use of a mobile POS terminal checkout stands so long as the POS transactional data includes a location of the mobile POS terminal checkout stand at the time of purchase, or information sufficient to determine a location of the mobile POS terminal checkout stand at the time of a given POS transaction.

Mobile payment devices 105A, 105B, 105C may be, for example, mobile phones, smart phones, tablet computers, laptop computers, or the like. The merchant server 115 and wholesale supplier server 160 may be, for example, computers utilized by merchants, and suppliers to merchants, respectively.

Connection to the network 150 shown in FIG. 1, or direct connection between computing devices, may require that the computers execute software routines which enable, for example, the seven layers of the Open System Interconnection (OSI) model of computer networking or equivalent in a wireless phone or wireless data network. The network 150 comprises computers, network connections among the computers, and software routines to enable communication between the computers over the network connections. The network 150 may comprise, for example, an Ethernet network and/or the Internet. Communication among the various computers and routines may utilize various data transmission standards and protocols such as, for example, the application protocol HTTP. Transmitted data may encode documents, files, and data in various formats such as, for example, HTML, XML, flat files, and JavaScript Object Notation (JSON).

While components may be discussed herein as connecting to the product analytics server 700 or to the product analytics database 300, it should be understood that such connections may be to, through, or via the other of the two components. References herein to “database” should be understood as equivalent to “datastore”. The merchant server 115, the wholesale supplier server 160, the POS terminal checkout stands 182A, 182B, 182C, and the mobile payment devices 105 may comprise a database. Although illustrated in the figures as components integrated in one physical unit, the computers, servers and databases may be provided by common, separate, or distributed physical hardware and common (or separate) logic processors and memory components.

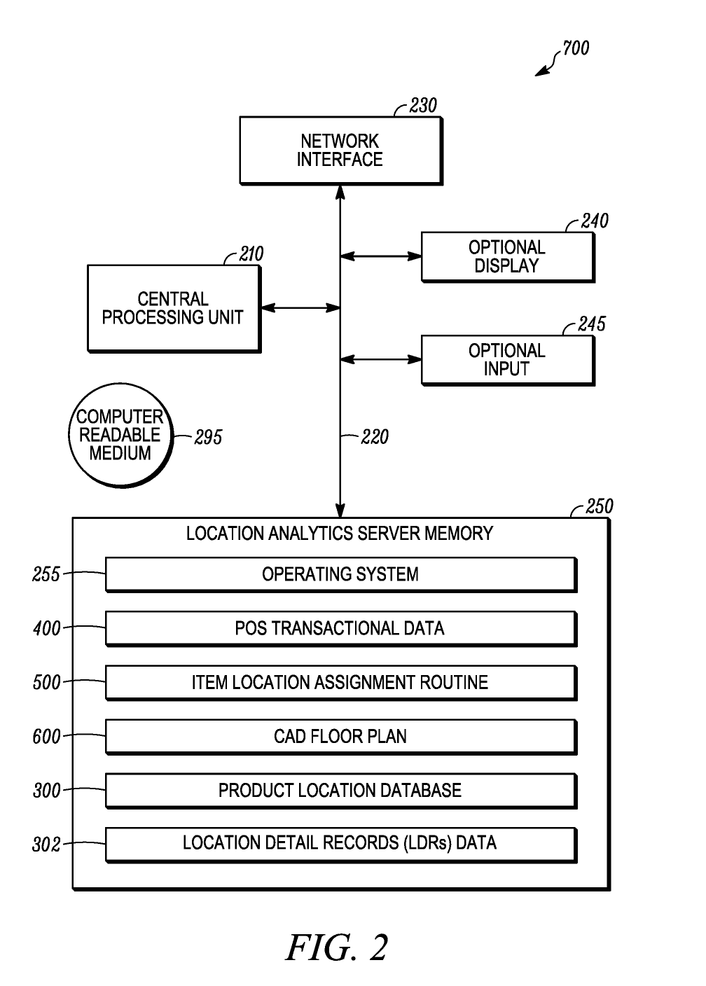

FIG. 2 is a functional block diagram of an exemplary product analytics server 700 and relevant data structures and/or components thereof. The product analytics server 700 comprises at least one CPU processing unit 210, product analytics server memory 250, an optional display 240, an optional input device 245 (e.g., keyboard), and a network interface 230, all interconnected via a bus 220. The network interface 230 may be, e.g., an Ethernet interface, and may be utilized to form connections with the network 150 (FIG. 1). The network interface 230 may be wired and/or wireless.

A DVD, USB thumb drive, or other computer readable medium 295 may preferably be used by the product analytics server 700 via a suitable interface (e.g., a DVD player, or a USB interface, respectively). The location detail records (LDRs) and POS transaction receipt data (if available) may be input to the product analytics server 700 via the network 150, or via the computer readable medium 295 or other appropriate data input device such that potential mediums to hold POS data include a DVD, CD-ROM, memory card, or USB thumb drive. LDRs and POS transaction receipt data may also or alternatively be stored in the product analytics database 300 via communication over the network 150.

The product analytics server memory 250 generally comprises a random access memory (“RAM”) such as SDRAM (synchronous dynamic random-access memory) and/or a permanent mass storage device, such as a disk drive. The product analytics server memory 250 stores program code for software routines, as well as browser, webserver, email client and server routines, camera, other client applications, and database applications. In addition, the product analytics server memory 250 also stores an operating system 255. Software components may be loaded from the non-transient computer readable storage medium 295 into the product analytics server memory 250 using a drive mechanism (not shown) associated with a non-transient computer readable storage medium 295, such as a DVD/CD-ROM drive, memory card reader, USB bus, etc. In some embodiments, software components may also or instead be loaded via a mechanism other than a drive mechanism and a computer readable storage medium 295, e.g., via the network interface 230.

The input 245 of the product analytics server 700 may comprise hardware supported input modalities such as, for example, a touchscreen, a keyboard, a mouse, a trackball, a stylus, a microphone, an accelerometer(s), a compass(es), RF receivers (to the extent not part of the network interface 230), and/or a camera.

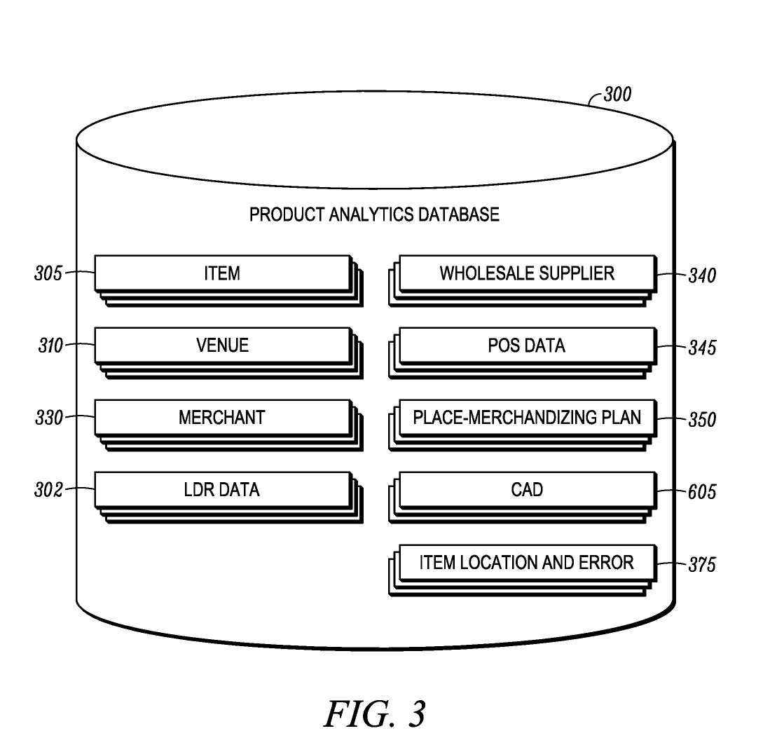

The product analytics server 700 may comprise, or communicate with via the bus 220, the product analytics database 300, illustrated in detail in FIG. 3. In some embodiments, the product analytics server 700 may communicate with the product analytics database 300 via the network interface 230. The product analytics server 700 may, in some embodiments, include many more components than those shown.

Referring again to FIG. 2, the product analytics server 700 may comprise various data groups and control routines, which are discussed at greater length herein. Webserver and browser routines may provide an interface for interacting with the other computing devices illustrated in FIG. 1, such as with the merchant server 115, the wholesale supplier server 160, and even in other embodiments indirectly with the mobile payment devices 105, (all which may serve and respond to data and information in the form of webpages and html documents or files). The product analytics server 700 may store point of sale (POS) transaction data 400 and location detail records (LDRs) 302, along with a product location database 300.

The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 3 is a functional block diagram of an exemplary product analytics database 300 including data utilized and created by the product analytics server 700, in accordance with the principles of the present invention.

In particular, a primary purpose of the product location database 300 is to maintain a reliable and complete database including a location of every item in a retailer's product line or catalog.

In addition to the data groups explicitly illustrated in FIG. 3, additional data groups may also be present on and/or executed by the product analytics server 700. Moreover, routines for databases, webservers, and web browsers, and routines enable communication with other computers. The data groups used by routines may be represented by a cell in a column or a value separated from other values in a defined structure in a digital document or file. Though referred to herein as individual records or entries, the records may comprise more than one database entry. The database entries may represent, or encode numbers, numerical operators, binary values, logical values, text, string operators, joins, conditional logic, tests, and similar. The browser routines may provide an interface for interacting with other computers through, for example, a webserver routine (which may serve data and information in the form of webpages). The web browsers and webservers are meant to illustrate or refer to user-interface and user-interface enabling routines generally, and may be replaced by equivalent routines for serving and rendering information to and in a user or device interface. Log-in credentials and local instances of user or device profiles may be stored in or be accessible to the product analytics server 700, the merchant server 115, and/or the wholesale supplier server 160. User or device profiles may be utilized to provide secure communication between computers.

The software routines, as well as data groups used by the software routines, may be stored and/or executed remotely relative to any of the computers.

The components of the product analytics database 300 are data groups used by routines and are discussed further herein. Though referred to herein as individual records or entries, the records may comprise more than one database entry. The database entries may be, represent, or encode numbers, numerical operators, binary values, logical values, text, string operators, joins, conditional logic, tests, and similar. In addition to the data groups used by routines, log-in credentials and local instances of customer and user profiles may be stored in or be accessible to all of the computing devices illustrated in FIG. 1.

The product analytics database 300 may contain, e.g., an item database 305 listing all items available at a given store, a venue database containing relevant information about the various venues 310, a merchant database 330 containing relevant information about relevant merchants, a location detail records (LDR) database 302 containing LDR data for shoppers at one or more venues. A wholesale supplier database 340 may contain information relevant to the wholesale suppliers to the venues. A point of sale (POS) database may contain POS transaction data relevant to the venues. A place-merchandizing plan 350 may contain information about location of items. A CAD database may contain map information for each of the venues. An item location and error database 375 may contain information about where each of the items is located in each of the venues.

It is recognized that items in a store or venue are of course located or displayed at a given location (e.g., on a given rack, or folded on a shelf in a given fixture within the store or venue). It is also appreciated that in larger department stores, checkout stands are typically distributed throughout the store, e.g., with one checkout stand, or a cluster of checkout stands, within each department. The product analytics system in accordance with the present invention, to fill gaps in LDR data, makes use of the relationship between the location of items in a store and the need to present the same at a checkout stand to complete a purchase.

For purposes of the present invention, any suitable location assignment system for building the item location database 375 within or associated with the product location database 300 may be implemented. For instance, one suitable location assignment system for assigning location to all items in a store or venue is disclosed in co-owned U.S. Pat. No. 9,824,388, the entirety of which is explicitly incorporated herein by reference.

Another suitable location assignment system for assigning location to all items in a store or venue is disclosed in co-owned U.S. application Ser. No. 15/702,595, the entirety of which is explicitly incorporated herein by reference.

Still another suitable location assignment system for assigning location to all items in a store or venue is disclosed in co-owned U.S. application Ser. No. 15/814,308, the entirety of which is explicitly incorporated herein by reference.

Ideally the location assignment system implemented to build the item location database 375 has the capability to recognize and accommodate items inside the store that move on a daily basis, and assigns and stores a location based on the items' new location. For instance, in a location assignment system disclosed in U.S. application Ser. No. 15/833,402, filed Dec. 6, 2017, point of sale (POS) transaction data may be used to generate a physical location of items available within a store. Point of sale based, checkout stand anchored location assignment of products is a very scalable solution for large store and multi-store retailers and department stores. The location assignment system assumes that some location anchor is available, as is a regular feed of data that ties items (products) to the location anchors, as well as location data that ties the location anchors to other locations in the store without any anchors. Checkout stands serve as location anchors, and point of sale (POS) terminal checkout receipt data serves to tie the items to checkout stands. U.S. application Ser. No. 15/833,402 is explicitly incorporated herein by reference.

Given the ability to obtain accurate and current location information for all items within a store, the present invention provides an improved analytical system useful to merchants and others desiring to increase the efficiency and profitability of a given store or retail system.

The present invention uses indoor positioning data to generate analytics providing visualization of traffic flow in a retail location. The indoor positioning data is recorded by a shopper's smartphone while running an appropriate location engine. Importantly, the present invention also fills in the gaps typical in indoor positioning data to provide a complete visualization of a given shopper's journey through a given store.

In aggregate, knowledge of customer traffic flow might not seem to be capable of providing much meaningful information. However, in accordance with the invention, indoor positioning data is articulated—and importantly augmented to completion using paths taken as determined by point of sale (POS) transaction data. The particular shoppers visualized may be filtered by a specific item purchased, dwelled upon, or even just recommended in an active location-triggered recommendation transmitted to the shopper in real-time as they journeyed through the store. Other filter attributes may instead be by a specific brand purchased. The journeys of brand-filtered shoppers, gaps in which may be augmented and completed using the location of items determined using POS transaction data (if available), are visualized using a generated map to allow specifically interested merchants to determine where in a given store that people who bought certain products walked; to determine which items or brands were purchased together; and perhaps most importantly to determine the success of dwells and/or impressions made on a customer as they walked between the items that they did ultimately purchase, or as they passed by items recommended but not purchased, etc.

In one aspect of the invention, visualizations are generated to provide a mapped image of the actual pathways that customers who purchased one type item, or one type brand of item, or a specific item, or specific co-purchased items, took, to the extent reported. Gaps in the reported pathways taken by customers are filled in, or augmented, based on point of sale (POS) transaction data so that a complete journey through the store is visualized.

The visualization provides a map of where customers who bought, e.g., “Scotts” brand items walked within a given store, for comparison to a visualization of where customers who bought, e.g., “Rubbermaid” brand items walked within that same store. In this way a merchant may identify, e.g., any distinctly different traffic patterns.

The generated visualizations provide for the extraction of “advertising data”—like inferences. For instance, with the indoor positioning data-based analytics system, a merchant can determine that people who bought Rubbermaid brand items were exposed to certain other brands as a result of their journey (walking) through the store. This gives visibility into spatial product relationships based on real data, in particular based on indoor positioning data such as location detail records (LDRs), as augmented to fill in gaps in the journey using point of sale (POS) transaction data, and based on spatial layout data for the given store.

Frequent, obvious associations between certain branded items are known based on a significant amount of brute force, labor intensive analytics of relationships between products, i.e., that in general people who buy X also tend to buy Y. This brute force analytics requires an analysis between pricing, deals and other marketing impacts on sales. However, the present invention provides the ability to generate unexpected, unintended, subtle, and perhaps unrelated associations between items available within a same store—particularly when the association is a result of a location of the unrelated item.

For instance, the present invention provides the capability to identify a relationship and co-marketing opportunity for bundling between unrelated brands, e.g., Rubbermaid brand products with entirely unrelated Style Selections that even brute force analytics would not have identified.

“Dwell” is a term used herein to refer to bays that contain an item that was purchased.

“Impression” is a term used herein to refer to bays that are walked by or passed on a particular customer's journey through the store between bays that they “dwell” upon. Thus, the indoor positioning based analytics system determines impressions based on items along the way of a shopper's complete, augmented path through a store.

Thus, a unique and novel imagery and visualization of shopper traffic flow based on indoor positioning data is generated from a limited, filtered data set based on location detail records (LDRs).

The indoor positioning based system aggregates records by “hexgrids”—which is the method by which location detail records (LDRs) are collected and organized so they can be related to product locations.

A third party system inputs to the indoor positioning based analytics system to provide a shopper's indoor position/location information. The third party system is referred to herein as a location engine (LE). Location data output from the location engine (LE) is referred to herein as a location detail record (LDR). The location detail record (LDR) minimally contains time and position. Within the principles of the invention the location detail record (LDR) may additionally contain vector heading and/or accuracy information. Contents of the location detail record (LDR) may vary depending upon the particular third party vendor that provides a given location engine (LE).

The location data records (LDRs), when plotted on a map, show the user's path through a given store. The inventors herein have appreciated that in practice the positional information recorded for a given user may, and often is, incomplete for the entire instore shopping journey. For instance, depending on the settings on a user's phone, some users only allow location reporting when the app is in use. Thus, when a user closes the app and places their smarphone in their pocket during their shopping journey, generation of location data records (LDRs) would cease because in such cases the location engine (LE) would only be able to generate location data records (LDRs) while the shopper is using their phone or the user allows the mobile device to collect and report on location information while the application is not is use (“backgrounded”).

The product analytics system in accordance with the present invention ingests the location data records (LDRs), and plots the location data records (LDRs) on a map. The location-based analytics system then draws a route line to show the shopper's path through the store. These lines (line segments) are representative of the actual path taken by the shopper through the store.

However, importantly, where the location data records (LDRs) leave gaps in a shopper's journey (i.e., missing location data records (LDRs) as indicated by the time gaps and location changes), the inventive product analytics system fills in the pathway gaps by using a routing engine to generate routes between the last known position from the first LDR event to first known position from second LDR event, and so on for all the location data records (LDRs). If the last location data record (LDR) doesn't end at the checkout or exit, the product analytics system takes the last location data record (LDR) and appends a final route determined from point of sale (POS) transaction data signifying the end of the shopping journey. In this case it would be the identity and location of the particular checkout register used by that shopper.

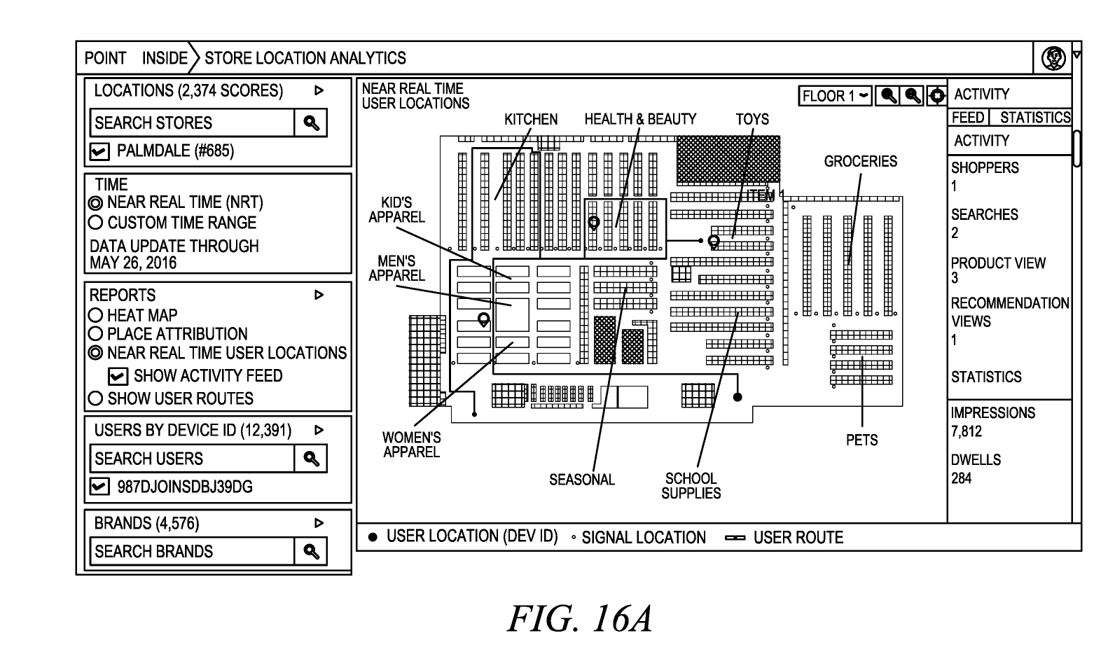

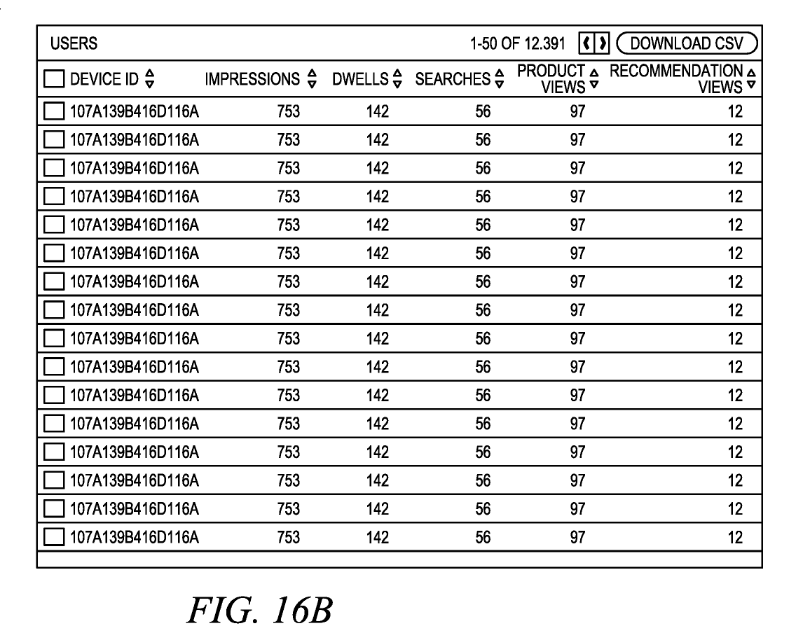

The product analytics system determines dwells based on the position data from the location data records (LDRs), augmented as necessary with routes determined between nodes and items located using POS transaction data (if available). For instance, if a particular item was purchased, but LDRs no not indicate a path to that item, then the product analytics system will add the location of the purchased item as a node in the shopper's journey through the store, and route to the closest node indicated by the LDR data using routing between the relevant nodes. See FIG. 16.

Point of sale (POS) transaction data may or may not be available, but if POS transaction data is available, the product analytics system based on indoor positioning data can augment the actual location data records (LDRs) with assigned positions of the shopper as determined using the location of each product purchased by that user using POS transaction data to locate the purchased item missing from the LDRs. Using the actual location data records (LDRs) together with assigned positions of the shopper to fill gaps in the LDRs, the product analytics system fills in all pathway gaps for a given shopper, thus enabling more useful visualization of the impact of marketing efforts in the store.

The disclosed product analytics system generates either (1) a single shopper's path depicting individual shopper activity (selected from among a plurality of single shoppers having purchased a given item or brand); (2) a Blue dot “heatmap” depicting aggregate activity of a plurality of shoppers over a selected time window or windows over a given number of days; or (3) a brand affinity analysis.

### (1) A Single Shopper's Path Depicting Individual Shopper Activity

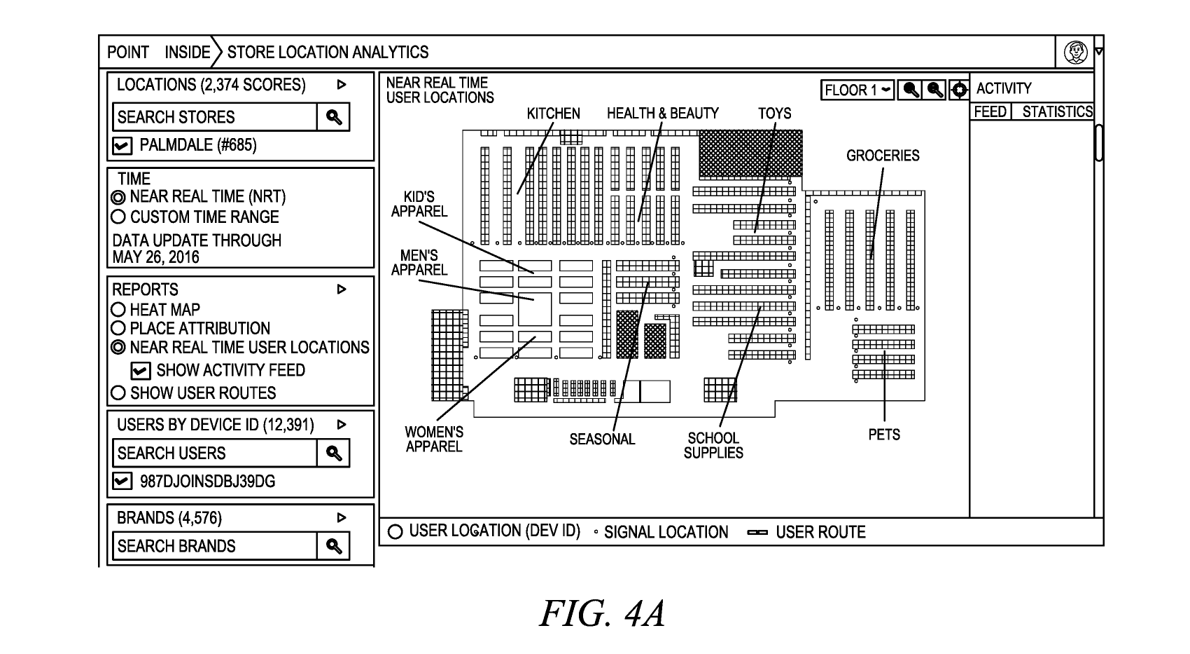

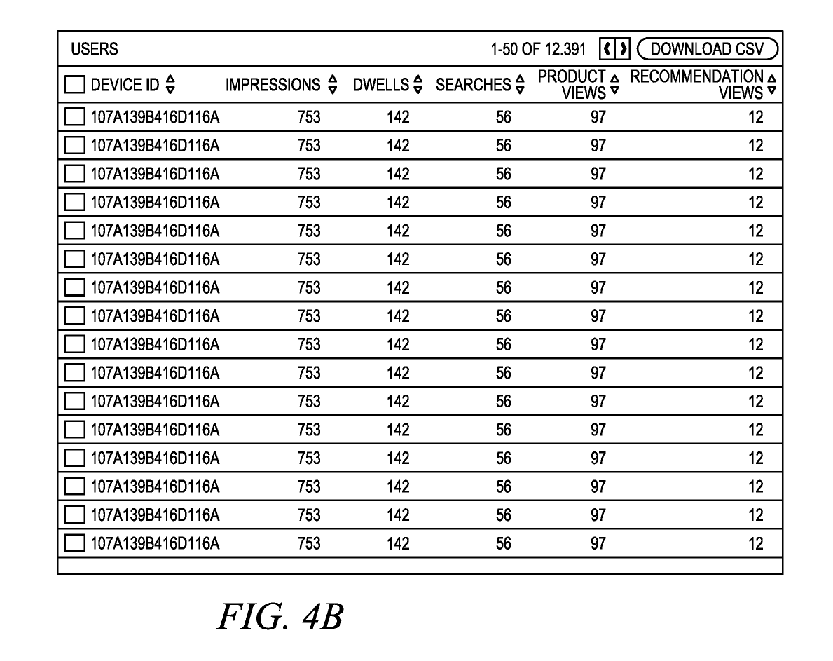

FIGS. 4A-14B show a creation of a user's pathway through a given store, as generated using location detail records (LDRs).

FIGS. 4A and 4B specifically show near real-time user locations in a map view of given shoppers in a given store, in an example of the present invention.

In particular, as shown in FIGS. 4A & 4B, the product analytics system starts with the map of the store that has all of the fixtures, aisles and products mapped to locations. On the right hand side of FIG. 4A is a list of activities relevant to the given shopper. For instance, activities may include items purchased, or items recommended to the shopper.

Along the left side of FIG. 4A is a selection menu enabling selection of a given store (in this case “Palmdale (#685)”. A target time may be selected, e.g., near real time is selected, though a custom time range is also possible. The type visualization to be generated is selected, e.g., a “heat map”, a “place attribution”, or a “near real time user locations”, with the ability to activate the activity feed. Users (i.e., shoppers) matching the criteria are listed at the bottom of the page, and a particular user's pathway may be viewed on the map presented in the center of FIG. 4A. In this case shopper “987” is selected. The matching shoppers may be filtered by brand at the bottom of the column on the left side of FIG. 4A.

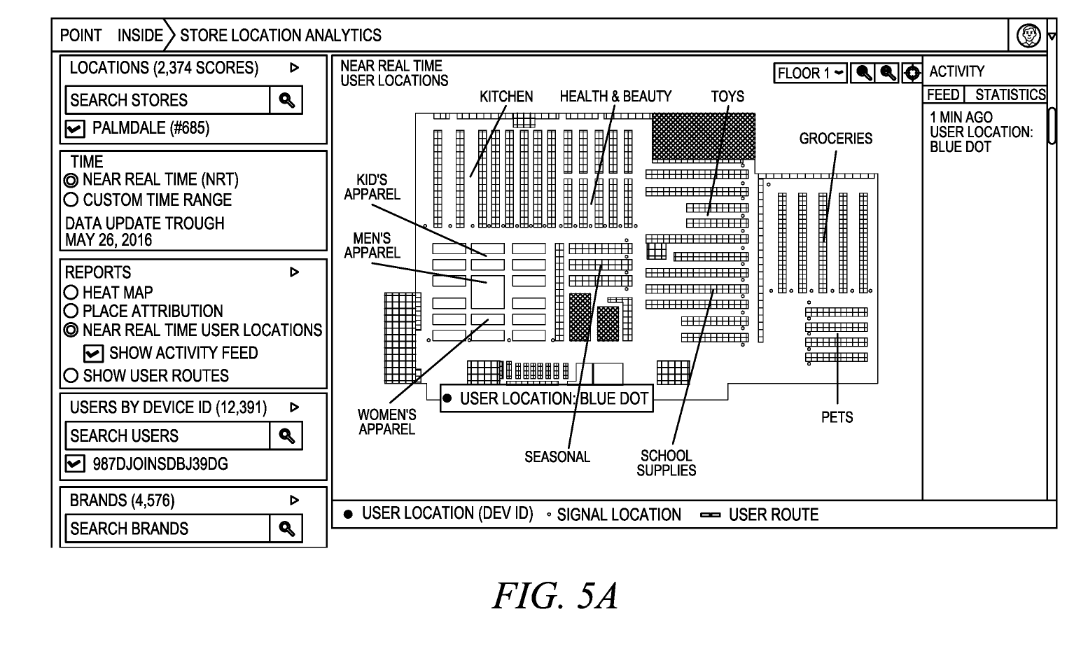

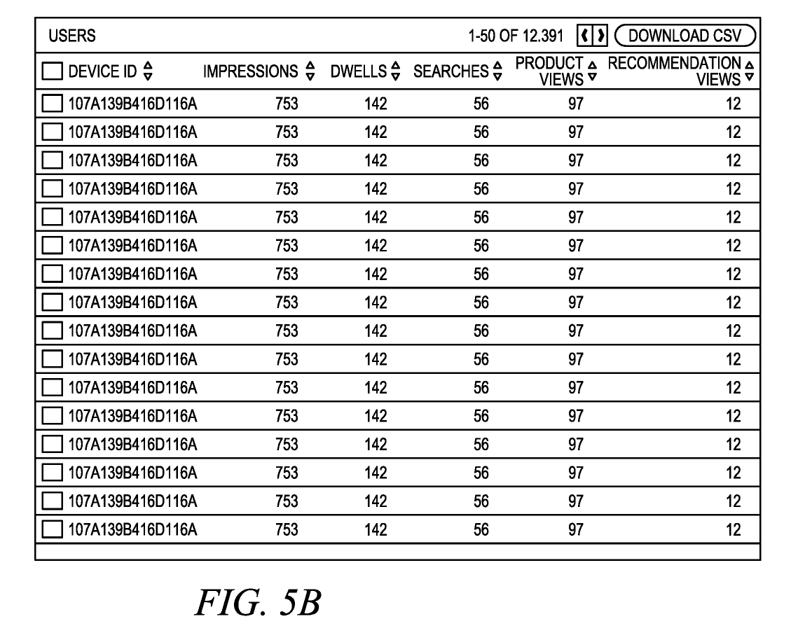

FIGS. 5A and 5B show a map view of a given shopper's location entering a given store in near real-time.

In particular, as shown in FIGS. 5A and 5B, when the given shopper enters the given store, a first signal is recorded that the shopper is in the store.

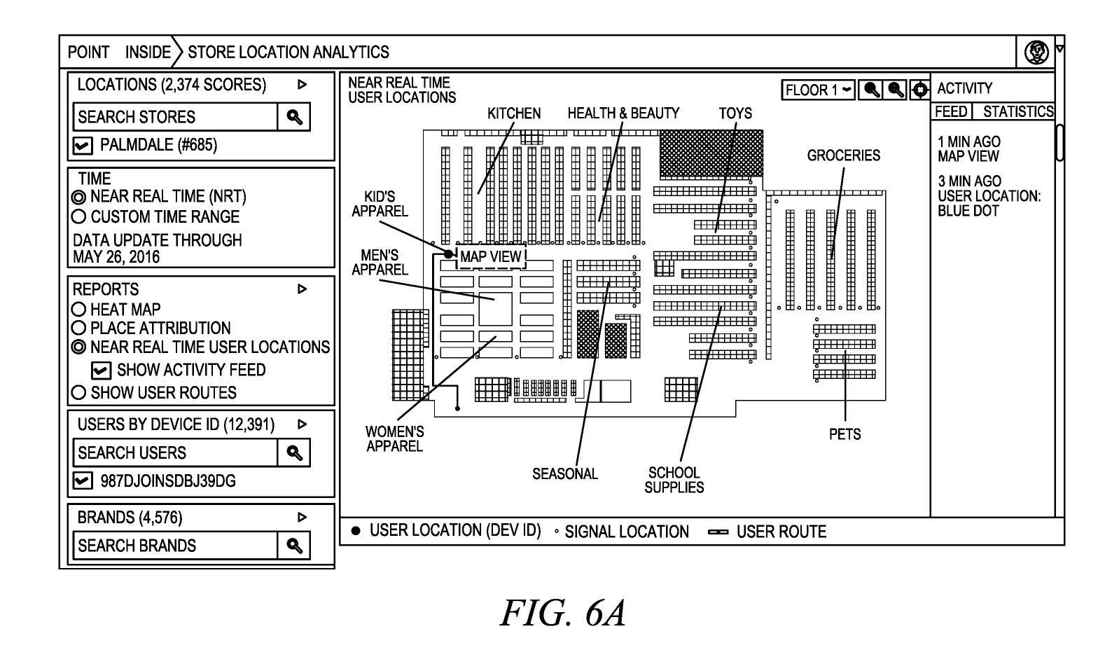

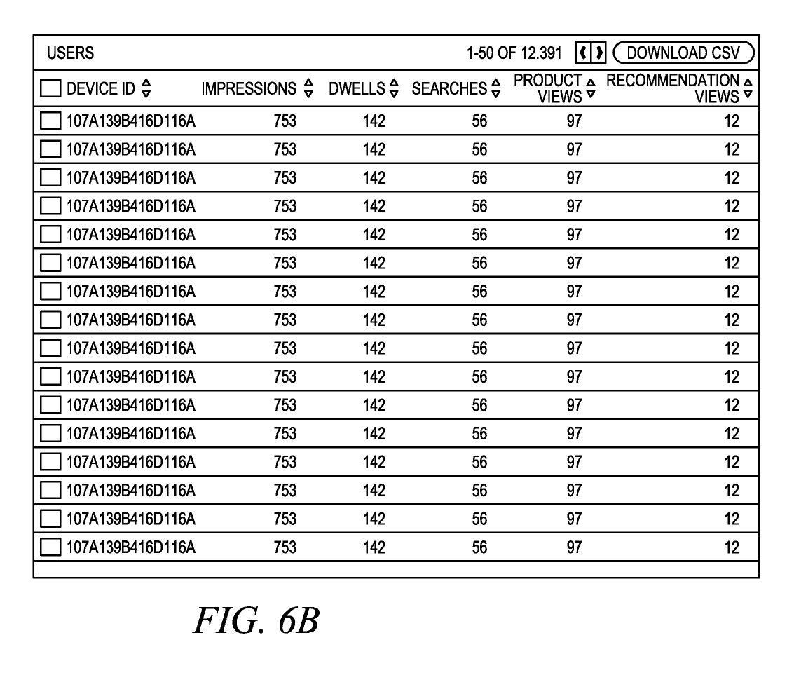

FIG. 6 shows a map view relevant to a first location detail record (LDR) showing the given shopper's path between their entrance into the given store to the location of the first location detail record (LDR).

In particular, as shown in FIGS. 6A and 6B, as the given shopper moves through the store, it is seen in FIG. 6A that the given shopper's location and the path that they take throughout the store. The location-based analytics system generates a blue dot notification on the map at the appropriate location in the activity feed upon the given shopper's entry into the store.

Note that FIGS. 4A-14B explain the creation of the shopper's pathway and experience in the given store in near real-time. However, the analytics performed by the product analytics system are performed not in real time, but rather after the shopping trip ends.

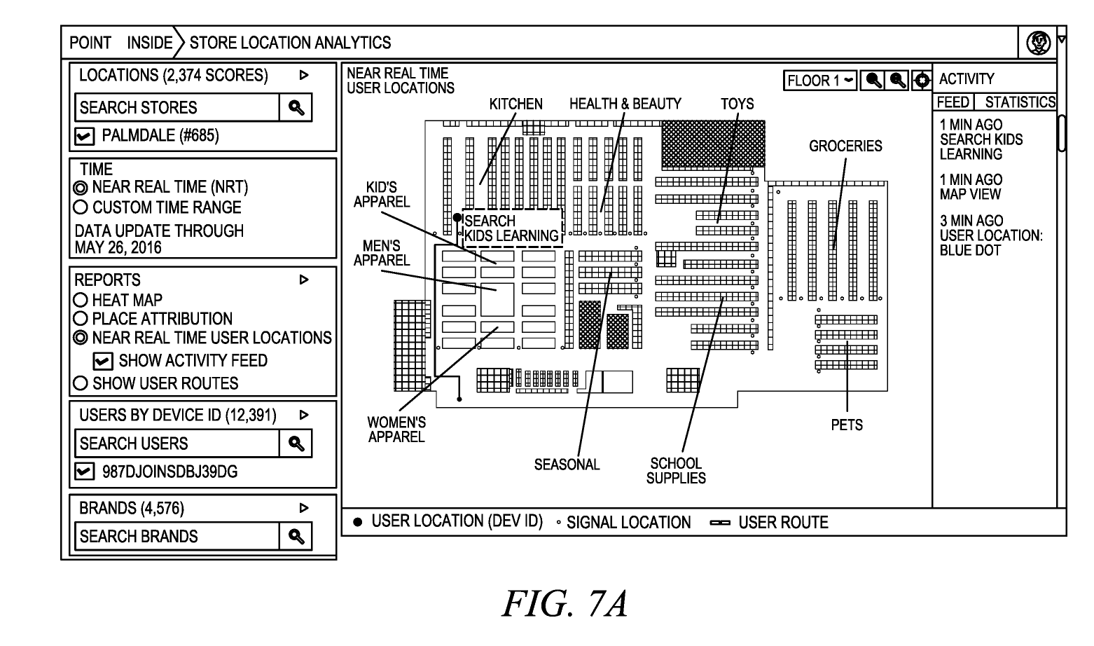

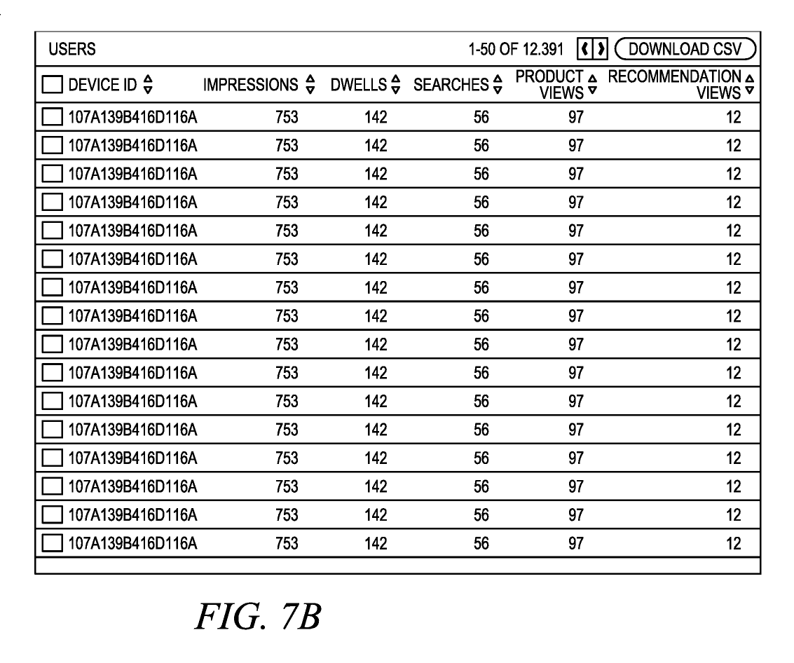

FIGS. 7A and 7B show a map view relevant to the next location detail record (LDR) as the given shopper enters a search for “Kids Learning” into the app they are running on their smartphone that includes a location engine (LE).

In particular, as shown in FIGS. 7A and 7B, the given shopper's mission is, e.g., to find a learning toy for their child, as determined by the given shopper's search in the app on their smartphone for the term “Kids Learning”. Given that such a search is not brand or product specific, a wide assortment of options are returned for the search term.

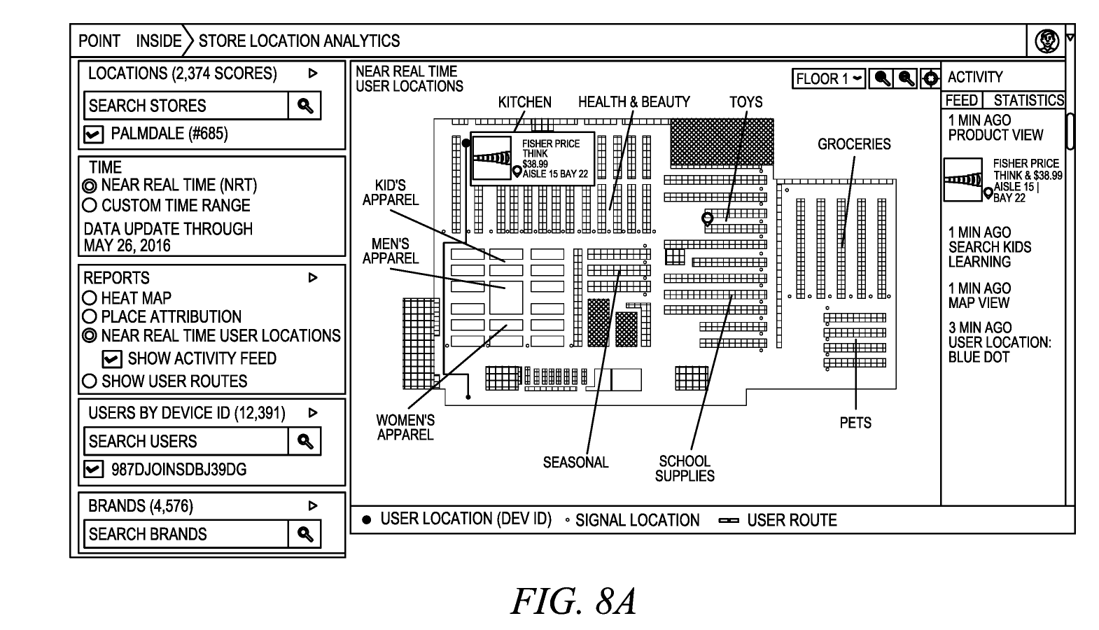

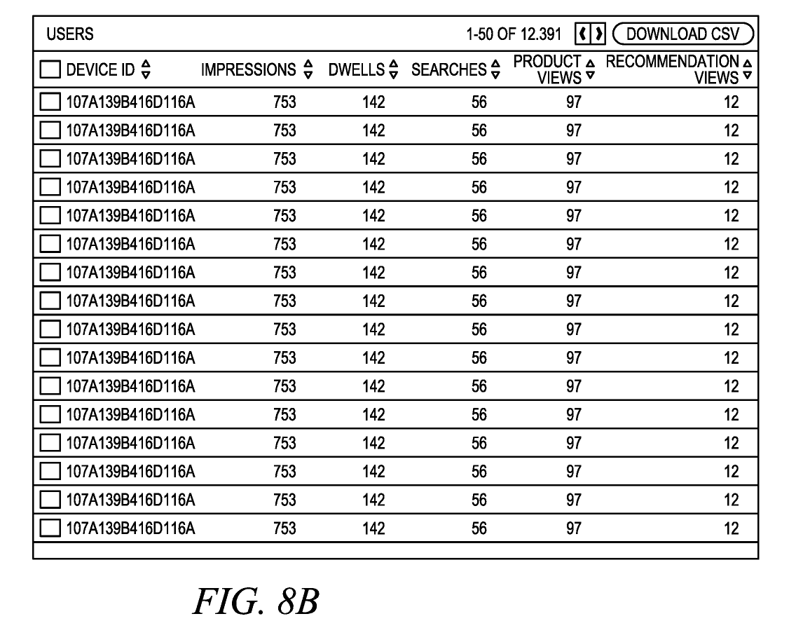

FIGS. 8A and 8B show a map view relevant to the next location detail record (LDR) as the given shopper selects “Fisher Price Think & Learn “Code-A-Pillar”.

In particular, as shown in FIGS. 8A and 8B, in the given example, the given shopper's search understandably generates the identity of multiple products in the store. The given shopper selects, e.g., the Fisher Price Think & Learn “Code-A-Pillar” (as confirmed by point of sale (POS) transaction data for the given shopper). The location of the selected item is seen on the store map depicted in FIG. 8A represented by a pin. Of course, any type representation of the selected item on the map may be implemented within the principles of the present invention.

As seen on the right hand column of FIG. 8A, an activity feed indicates the given shopper's selection of the item at the given shopper's location. Such selection of the item may be confirmed by the product analytics system with a match against point of sale (POS) transaction data.

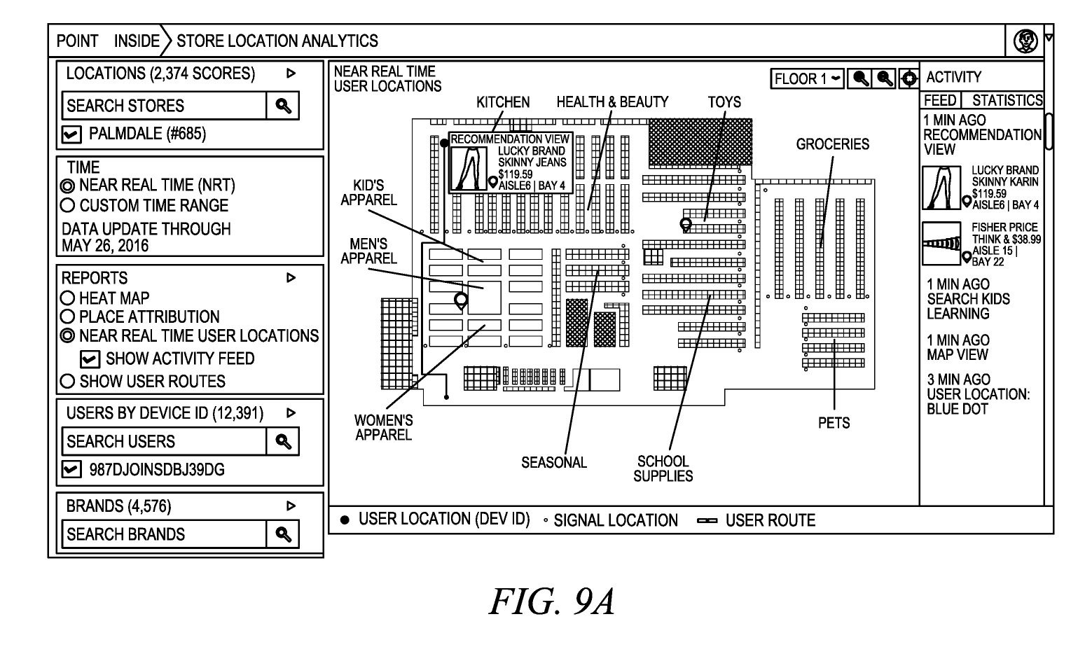

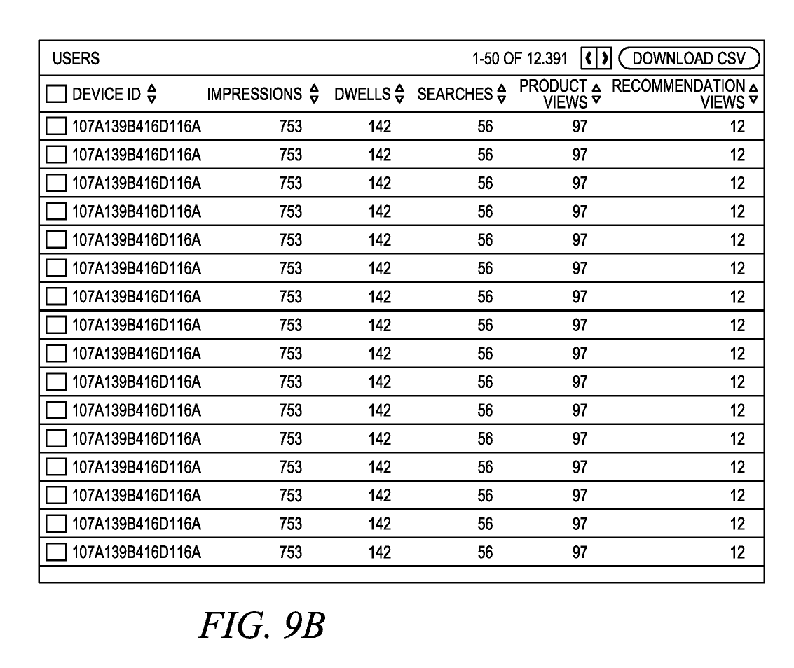

FIGS. 9A and 9B show a map view relevant to the next location detail record (LDR) as the given shopper receives a recommendation for jeans on sale.

In particular, as shown in FIGS. 9A and 9B, after selecting the first item at the store, e.g., the Fisher Price Think & Learn “Code-A-Pillar”, the given shopper may then receive a recommendation for an associated item, e.g., jeans on sale. In disclosed embodiments the recommendation for the associated item is sent to the given shopper within the relevant application program being run by the given shopper. However, the recommendation for the associated item may be sent to the given shopper outside the application program, e.g., via text. Ideally the recommendation for the associated item is sent to the user in real time so as to affect the given shopper's experience while on their pathway through the store. However, recommendations may be communicated to a given shopper after the conclusion of the shopping trip, as a result of analytics generated by the product analytics system.

The recommended associated item is ideally, in a real-time system, located in the store nearby to where the given shopper is currently, e.g., only a few departments away. Preferably, the vector direction that the given shopper is traveling in is determined, and the recommended associated item is generally ahead in the general direction of travel of the given shopper.

The recommended associated item may be selected based on a known shopping history of the given shopper. For instance, it may be recorded that the given shopper is a regular shopper of the given store. It may also be known that the given shopper has purchased items of the same type at that store previously, e.g., clothing. Based on past point of sale (POS) transaction data for the given shopper, the recommended associated item may be selected based on the given shopper's general interests. The recommended associated item may also be selected for presentation to the given shopper based in part on a promotional program established by or for the Brand of the recommended associated item.

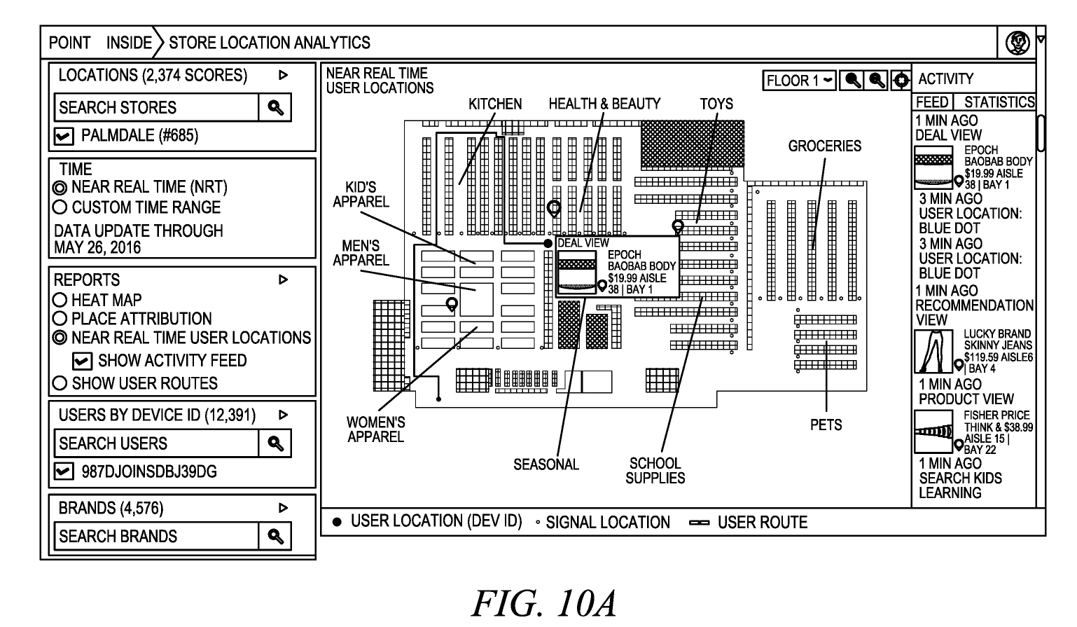

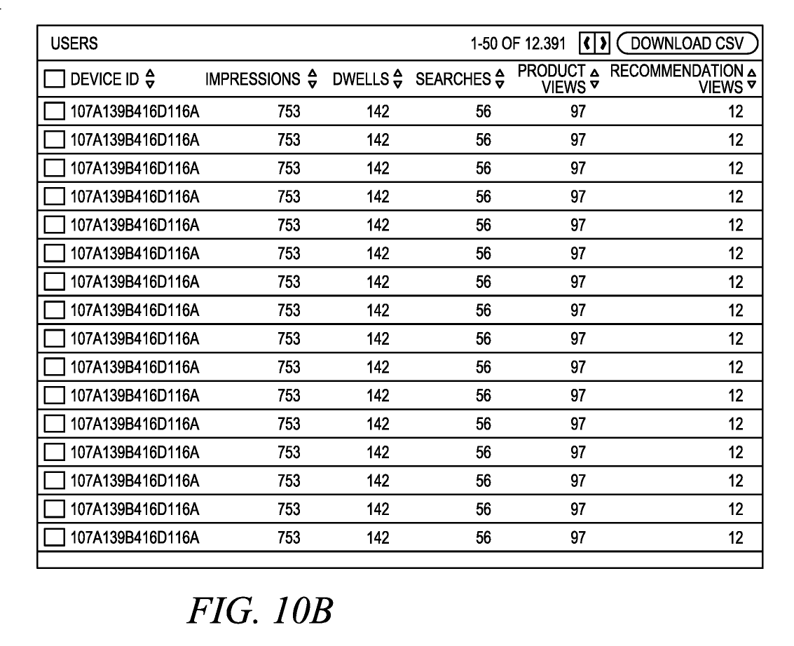

FIGS. 10A and 10B shows a map view relevant to the next location detail record (LDR) as the given shopper passes through the Cosmetics department in the store and receives a deal recommendation for body butter.

In particular, as shown in FIGS. 10A and 10B on the given shopper's way to the Toys department, the given shopper passes through the Cosmetics department and receives a deal recommendation message while the given shopper is passing through the Cosmetics department. This location-based triggering of the deal recommendation message is based on the shopper entering a defined area within the store (e.g., walking through the Cosmetics department). The content of the deal recommendation message is based, at least in part, on the given shopper's established profile.

As shown in FIG. 10A, the activity feed along the right side of the map maintains a record of how the store has engaged with the given shopper.

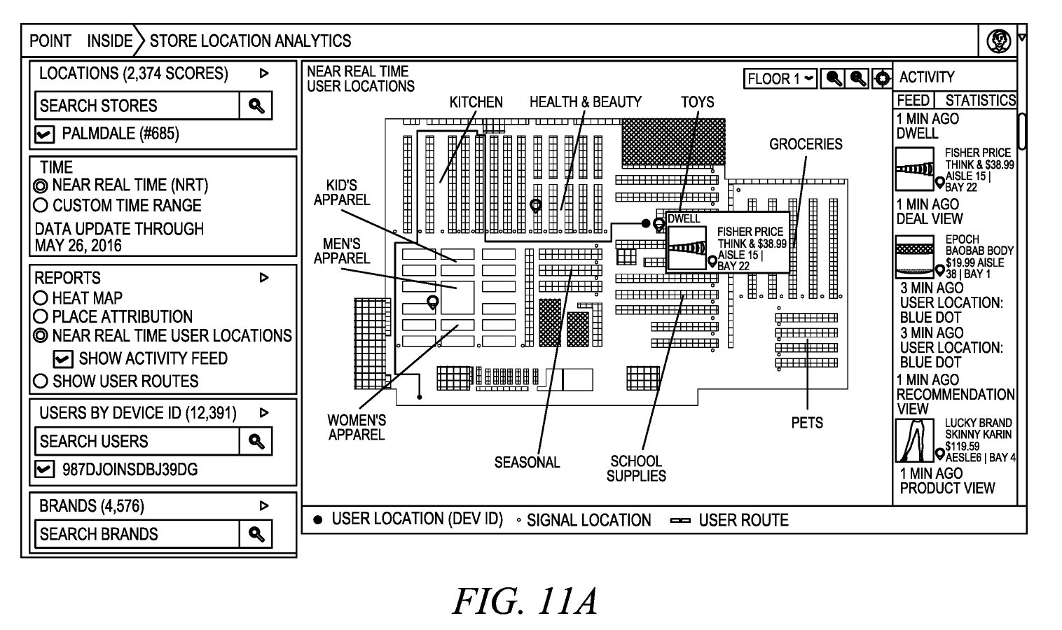

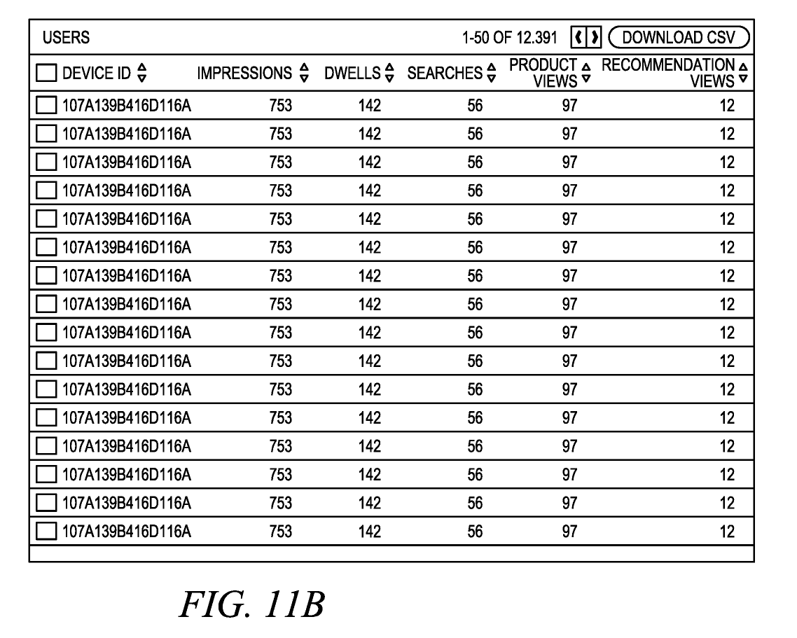

FIGS. 11A and 11B show a map view relevant to the next location detail record (LDR) as the given shopper reaches the Toy department and locates the toy that the given shopper selected in their search.

In particular, as shown in FIGS. 11A and 11B, the given shopper finally finds themself in the Toy department where they've easily located the Fisher Price toy that they originally searched for. The given shopper spends some time in the aisle, presumably inspecting and considering the item in the store, making sure it fits their needs and expectations.

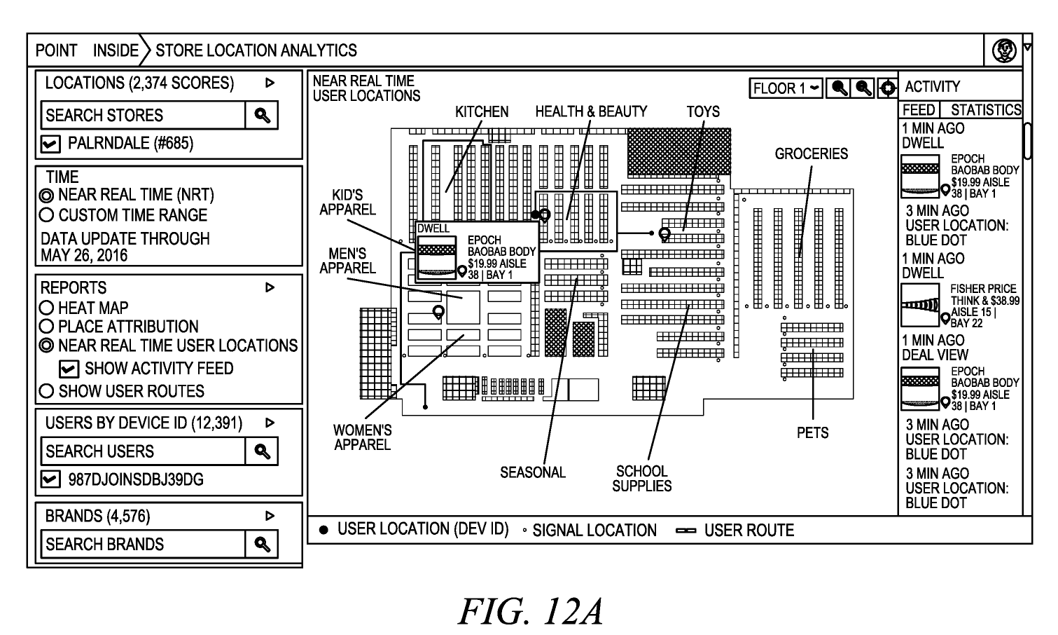

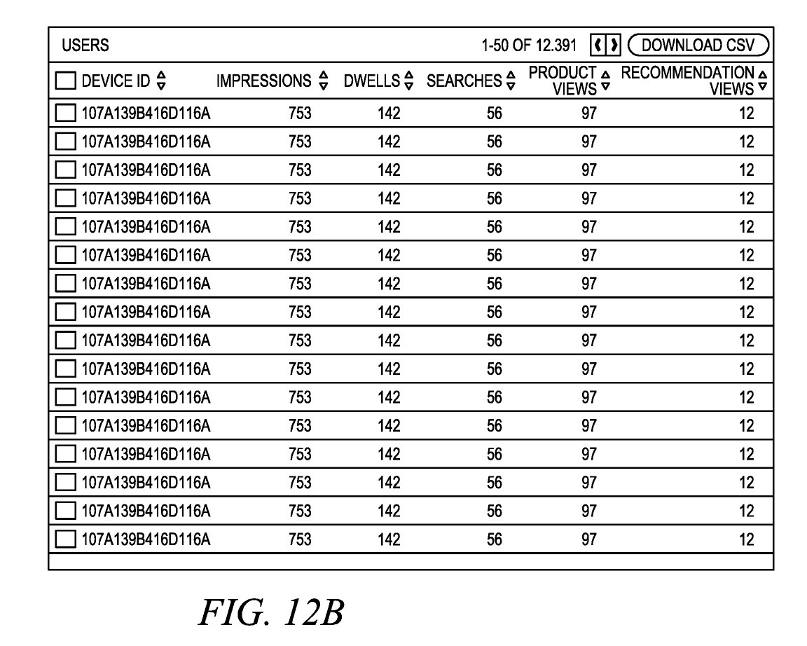

FIGS. 12A and 12B show a map view relevant to the next location detail record (LDR) as the given shopper doubles back to the previously recommended body butter in the Bath & Beauty department.

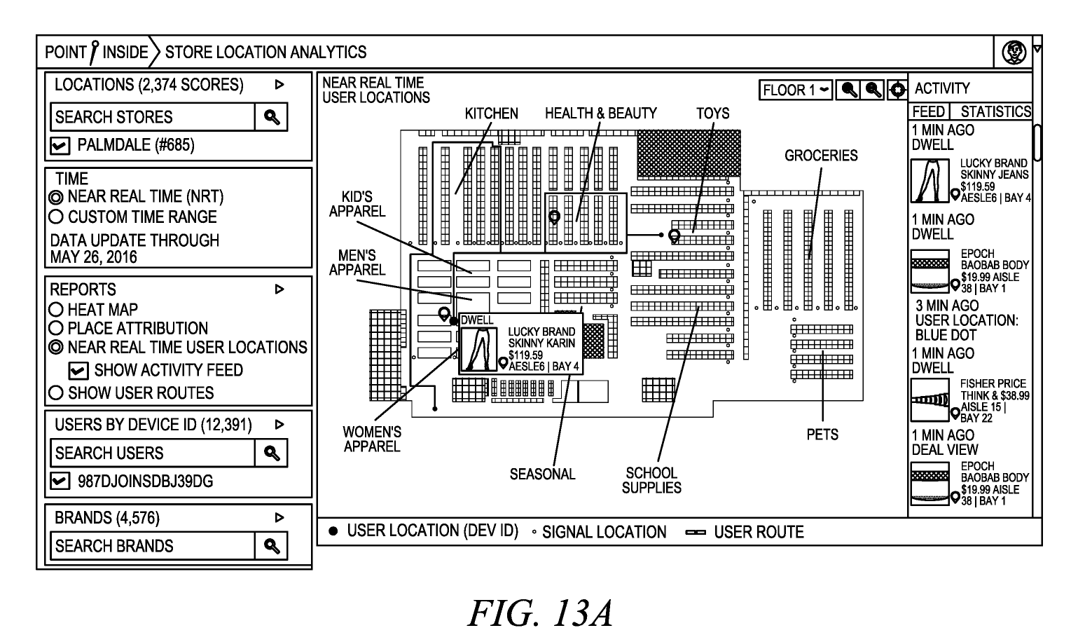

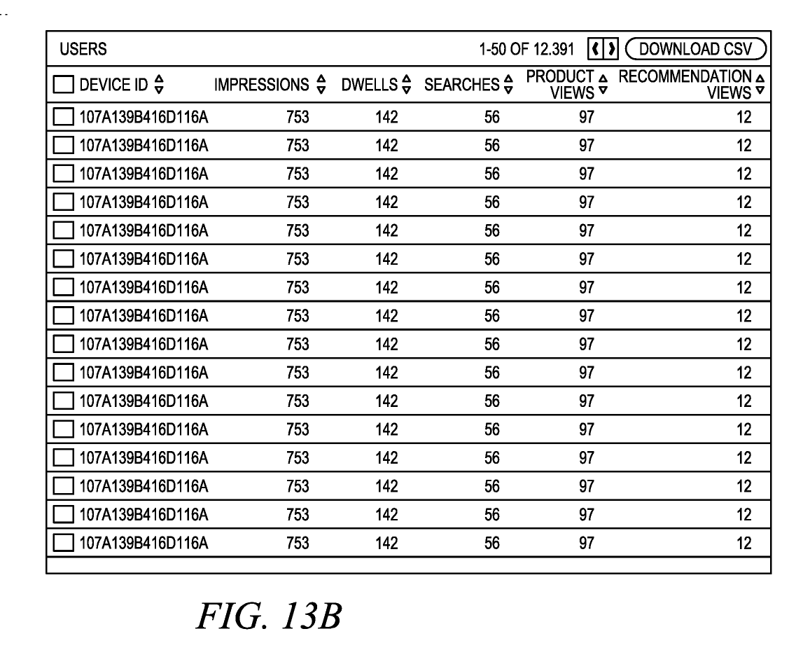

FIGS. 13A and 13B show a map view relevant to the next location detail record (LDR) as the given shopper also doubles back to the other previously recommended item, jeans on sale.

In particular, as shown in FIGS. 13A and 13B, the location data records (LDRs) indicate that the given shopper returns back to the location of the two items that were recommended for them.

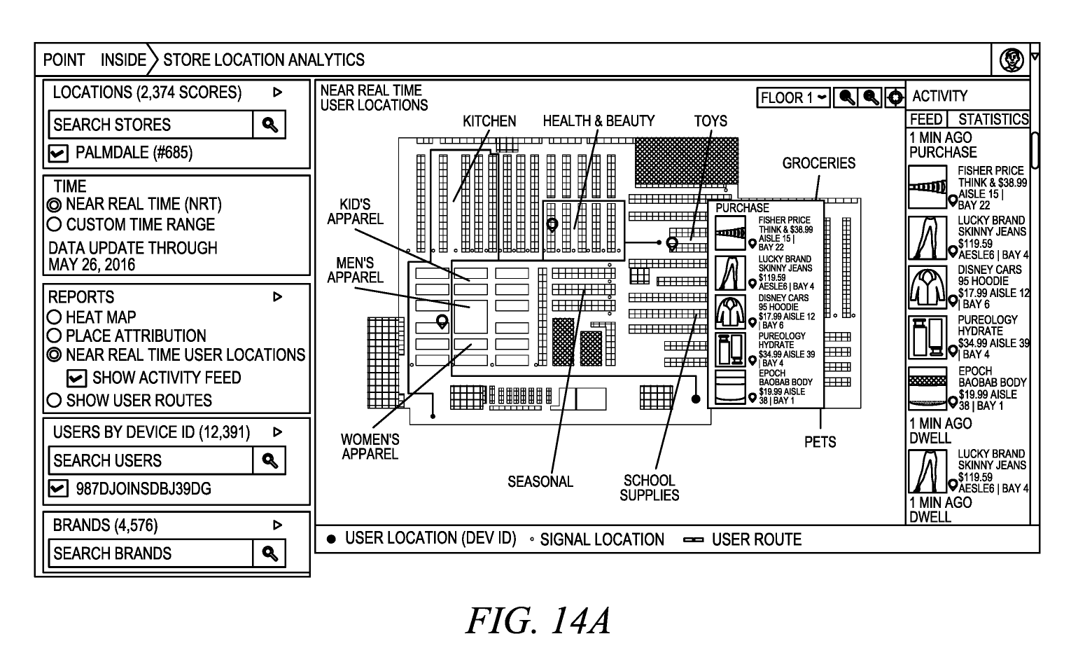

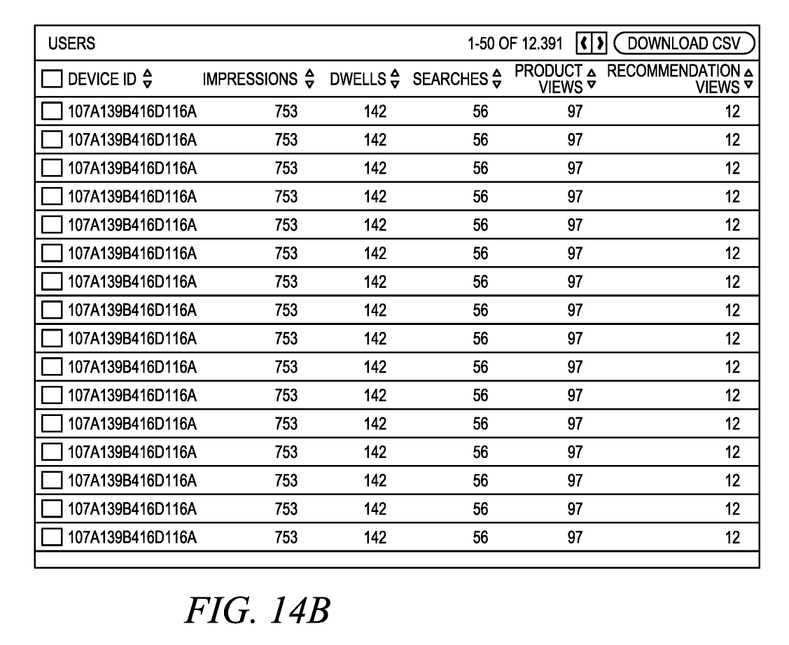

FIGS. 14A and 14B shows a map view relevant to the last location detail record (LDR) of the given shopper at a checkout lane where they purchase the three items.

In particular, as shown in FIGS. 14A and 14B, the given shopper proceeds to the checkout lanes. Point of sale (POS) transaction data for the given shopper may be used by the product analytics system to confirm that the given shopper purchased the three items.

As discussed, the product analytics server 700 fills in gaps in a shoppers journey so that a complete, uninterrupted pathway for a given shopper is generated. To do this, the product analytics server 700 utilizes point of sale (POS) transaction data.

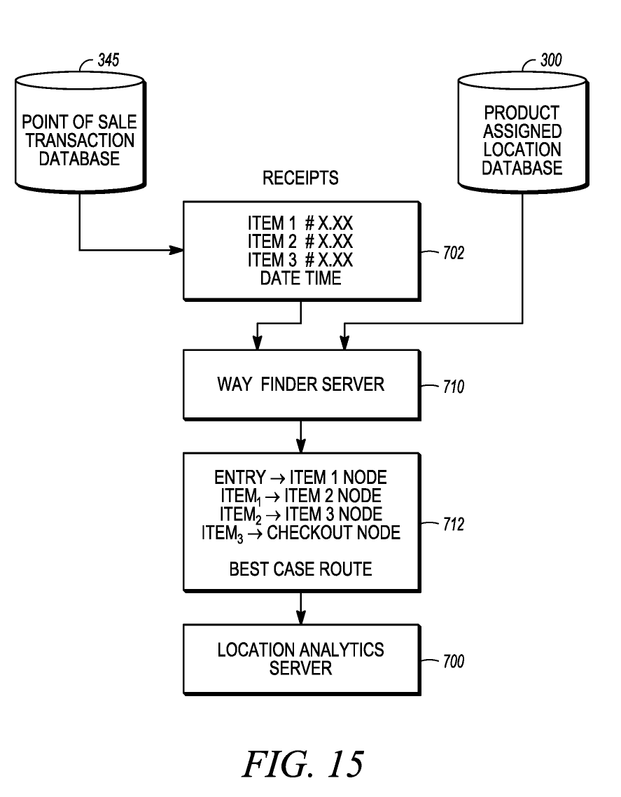

FIG. 15 shows input of point of sale (POS) transaction data to the product analytics server 700 in accordance with the principles of the present invention.

In particular, as shown in FIG. 15, point of sale (POS) transaction data collected in a suitable point of sale transaction database 345 provides transaction receipt data to a wayfinder server 710. The receipt data typically includes a list of items purchased, a priced at which they were purchased, and a date and time of the purchase. The receipt data may additionally include identification of the checkout stand used to make the purchase, and identifying information of the shopper.

The item location database 375 provides assigned locations for items in the store, e.g., the items purchased on the receipt data 702. The item location database 375 maintains, and provides, the location of all items (products) available in a store to the product analytics server 700.

The wayfinder server 710 obtains the point of sale (POS) receipt data 702 from the point of sale transaction database 345, and the location of each item purchased from the item location database 375. The wayfinder server 710 also obtains the location of the entrance(s) to the relevant store, and the location of checkout registers used. The wayfinder server 710 and the product analytics server 700 may be one and the same server, nevertheless providing their respectively disclosed functionalities.

The wayfinder server 710 then generates the best case route presumably taken by each customer based on a sequence of travel nodes based on their relevant transaction receipt 702. For instance, in the exemplary receipt 702 shown in FIG. 15 wherein the shopper purchased three items (item 1, item 2 and item 3), a best case route is generated for each of the following travel nodes:
NODE 1: From a default entrance to the assigned location of item 1;
NODE 2: From the assigned location of item 1 to the assigned location of item 2;
NODE 3: From the assigned location of item 2 to the assigned location of item 3;
NODE 4: From the assigned location of item 3 to the location of the checkout stand used.

The wayfinder server 710 includes a geographic map of the relevant store(s), including the location of walkways, entrances, and checkout stands. The wayfinder server 710 may also include within the geographic map of the relevant store(s) any other appropriate physical aspect of the store, such as the placement of walls or other barriers. Ideally the geographic map is updated as physical aspects of the store warrant.

In another embodiment, actual shopper location may be monitored by beacons or other monitoring devices mounted in the store while the shoppers carry an identifying device such as an RFID tag, or mobile device.

FIGS. 16A and 16B show a map view of a given shopper's journey through a store, but missing location detail records relating to a purchase of “ITEM 1” that is indicated in a point of sale (POS) transaction receipt. The product analytics server 700 adds a route to the ITEM 1 from the location of the Fisher Price toy purchased by the shown shopper.

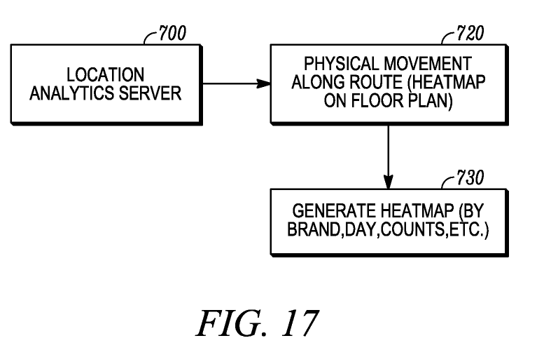

FIG. 17 shows an exemplary output function of the location analytics server wherein a “heat map” is generated by appropriate algorithms to provide location of all items in the relevant store, in accordance with the principles of the present invention.

In particular, as shown in FIG. 17, the product analytics server 700 determines physical movement of each shopper based on their LDRs, and using location information for all items in the store from the item location database 375 (as determined using POS transaction data if available) to form a location algorithm 750, generates shoppers' routes on a floor plan of the store as shown by algorithm 720. In algorithm 730 the product analytics server 700 generates a ‘heat map’ filtered by appropriate parameters chosen by the user. For instance, exemplary parameters to analysis include a heat map of dwells or impressions by shoppers' traversing their routes in purchase of, e.g., a particular brand of goods; or who shopped on a particular day; or who shopped within a window of time on particular days; or who purchased a particular count of items, etc.

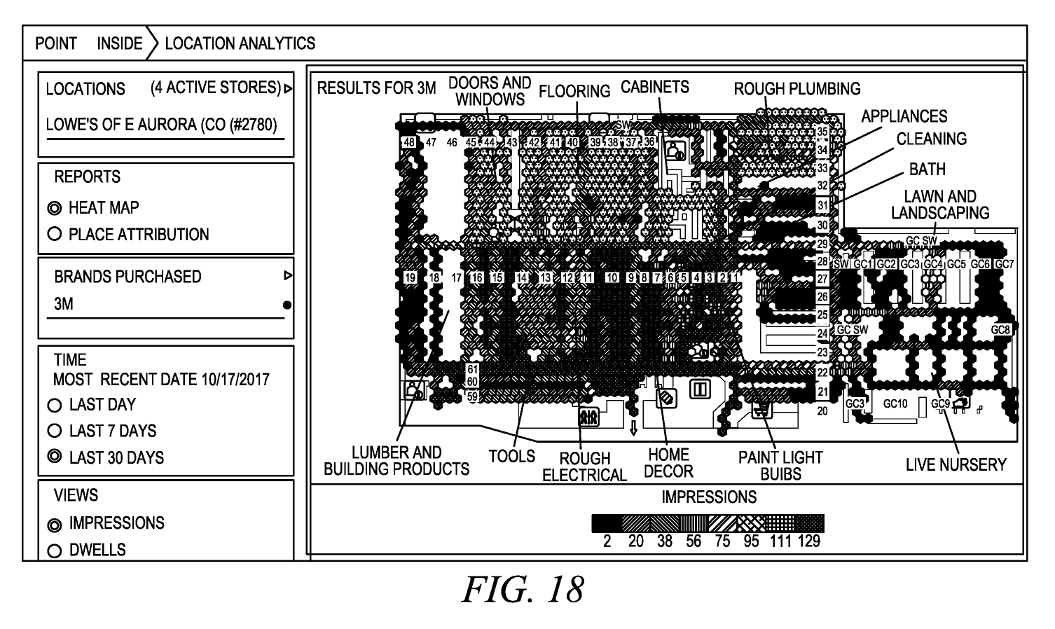

FIG. 18 shows an example of “impressions” for “3M” branded products, e.g., within a period of the past 30 days, depicted as a “heat map”, for a given store, generated by the product analytics server 700, in accordance with the principles of the present invention. For instance, as shown in the left column of the heat map generated by the product analytics server 700, a particular store within a large retail chain of stores is selected in the “LOCATIONS” parameter.

Generation of a “heat map” visual output is selected in the “REPORTS” parameter along the left side of FIG. 18, though any method of selection of a generated output, visual or tabular, is within the principles of the present invention.

Input of a filtering parameter “BRANDS PURCHASED” is selected, and one particular brand “3M” is selected in FIG. 18. More than one brand parameter may be selected for an amalgamated result. Moreover, instead of BRANDS PURCHASED, other filtering parameters may be implemented, e.g., COUNTS referring to the number of items purchased. Alternatively, a particular ITEM may be identified for filtering instead of BRANDS PURCHASED; or a CATEGORY of item may be identified for filtering; or a DEPARTMENT of type of items may be identified for filtering.

TIME is shown as being selectable between the “Last Day”, or “Last 7 Days”, or “Last 30 Days”. Of course, any particular time parameter may be implemented, e.g., within the past hour, within the past 6 months, within the past year. Also, a DATE parameter may be implemented, either separate from TIME or together with TIME. Thus, a heat map for customers who made purchases on any given DATE, or combination or DATES may be implemented. Or, combining TIME and DATE filtering parameters, a heat map may be generated for presumed customer paths for items purchased within a selected time slot (e.g., during rush hour 6 pm-9 pm), over the last 7 days, or over the last 30 days, or on every Sunday over the past year, etc.

Lastly, as shown in the VIEWS parameter of the heat map of FIG. 18, the product analytics server 700 may be directed to generate a heat map of “IMPRESSIONS” made by shoppers, or to generate a heat map of “DWELLS” made by shoppers. A heat map of “IMPRESSIONS” shows the number of times that shoppers (as filtered by the relevant parameters) over the filtered time period, walked by or passed directly within view, a bay, as determined by the particular shopper's best case route through the store between the bays at which they purchased an item. A heat map of “DWELLS” shows the frequency at which shoppers (as filtered by the relevant parameters) purchased items from the bays containing the items.

Thus, an impression is logged for each bay (or shelving fixture or other product display) on a path between two purchased items. If the two purchased items were located in the same bay, then no impression is logged other than for the bay containing the purchased items.

In large volume scenarios, the product analytics server 700 may generate a heat map showing normalized, or relative impressions and dwells, rather than an actual count of the impressions or dwells over the requested period of time. This is particularly useful for longer time frames, e.g., customers shopping over the past year.

As shown in FIG. 18, the heat map is depicted using a deepness of a particular color, e.g., blue, based on a number of impressions filtered by the selected parameters, based on shoppers who purchased items over the selected period of time.

Also as shown in the map of FIG. 18, each level of heat on the heat map is normalized so that the maximum number is represented by the hottest color, and is rounded to a nearest number. For instance, a lowest level of heat shows “2” or more impressions, up to the next heat level which shows “20” impressions, to the next heat level at “38” impressions, to the next heat level at “56” impressions, to the next heat level at “75” impressions, to the next heat level at “93” impressions, to the next heat level at “111” impressions, to the next heat level at “129+” impressions.

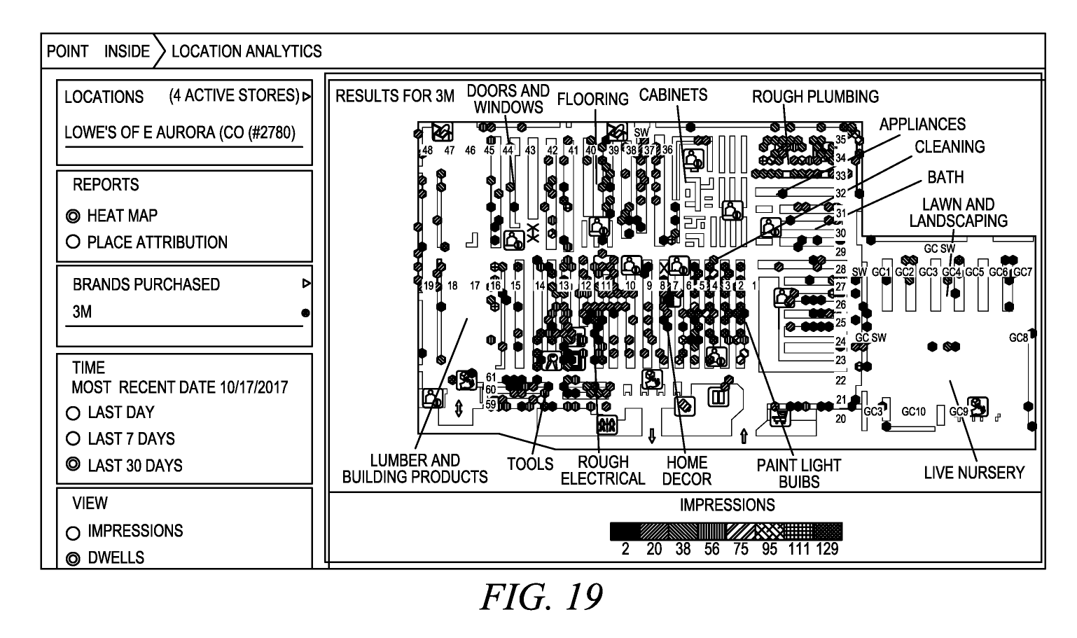

FIG. 19 shows an example of “dwells” for “3M” branded products, e.g., within a period of the past 30 days, depicted as a “heat map”, for a given store.

In particular, FIG. 19 provides the same filtering options as in FIG. 18, but generates a number of “DWELLS” for shoppers over the time period who purchased a “3M” product.

Among the useful analytical information provided by comparing the “impressions” shown in FIG. 18 with the “dwells” shown in FIG. 19, for the filtered parameters (e.g., for customers at the selected store who purchased a “3M” product over the last 30 days), is that a main corridor across the lower front of the store, while including checkout registers, etc., resulted in comparatively few dwells, or items purchased, whereas the primary, initial corridor through which customers first enter the store (past the light bulbs and home decor sections up the middle of the store) result in comparatively successful impressions (i.e., purchases from walking past).

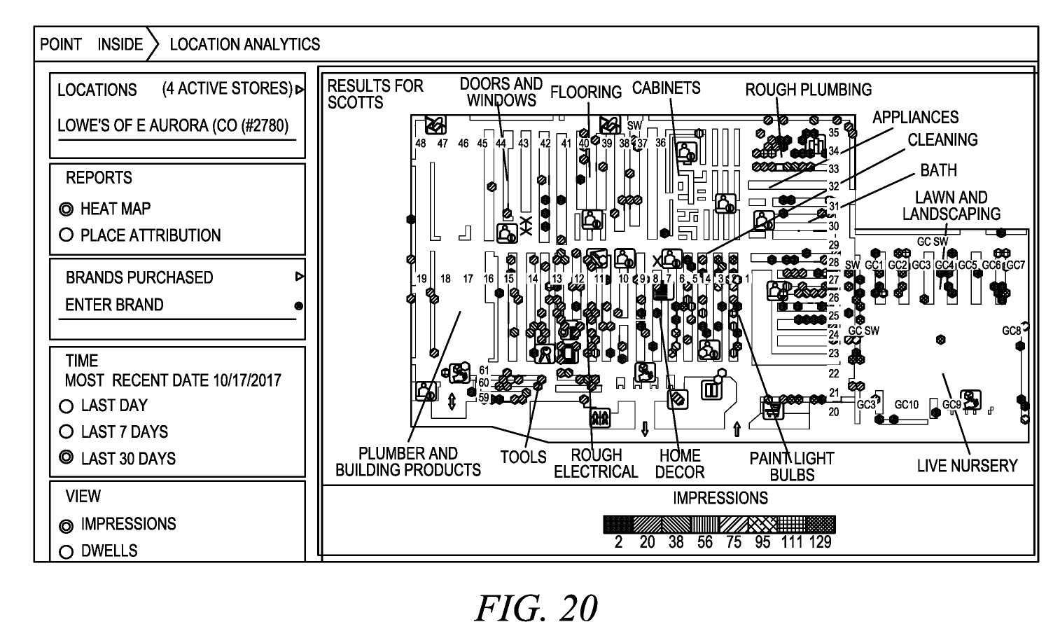

FIG. 20 shows an example of “dwells” for “Scotts” branded products, e.g., within a period of the past 30 days, depicted as a “heat map”, for a given store.

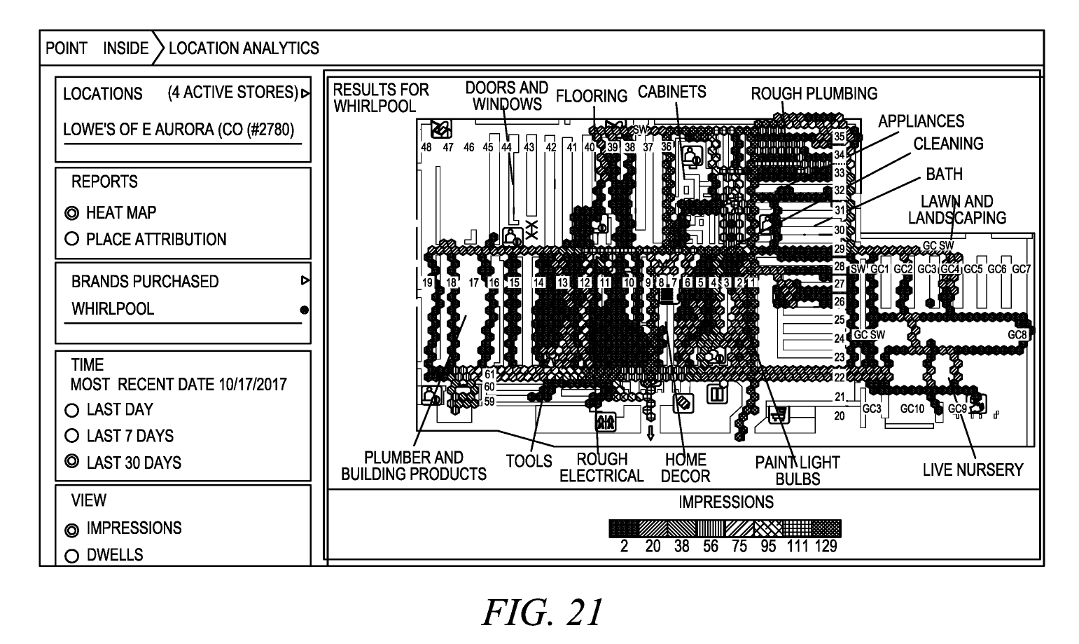

FIG. 21 shows an example of “impressions” for “Whirlpool” branded products, e.g., within a period of the past 30 days, depicted as a “heat map”, for a given store.

The present invention also generated customer “impression” data relating to items or display areas that a given customer did not purchase but were exposed to during their path through a store on a given day. Thus, a merchant is enabled to understand in greater detail that a customer who walked past (and thus “dwelled upon”) mops and other kitchen items did not purchase any of those items but did purchase a “Rubbermaid” bucket.

By definition, the bays in pathways that were walked past with no items purchased may thus be understood as an indication of a non-working impression. When the impression succeeds in getting a shopper to pick up an unintended item on the way, it shows up as a POS purchase (e.g., the “Rubbermaid” bucket).

With statistically sufficient information it may be possible using the present invention to determine a probability that a given shopper may have bought a second item within the “dwell” area because of an “impression” that they experienced on their way to an item that was actually purchased.

For instance, the present invention may identify commonly co-purchased items, and then predict that a third item purchased by a given customer of one (or both) of the co-purchased items was likely caused by their walking by, i.e., the result of a successful impression.

The determination of the success of an impression can also be determined if the intent of a shopper can be inferred based on their POS transaction. For example, if a sufficient number of items are purchased (either on a single POS transaction receipt, or on a number of recent POS transaction receipts tied together through use of a common frequent buyer card), then a probability of the intent of the customer's visit may be inferred, e.g., items typically purchased to build a new sandbox project. Then, if an unrelated item is purchased during a particular one of those shopping visits, it may be inferred that the purchase of that unrelated item is likely to due to a successful “impression”.

Thus, the present invention enables visualization not only as to the quantity of impressions by customers, but also as to the success of those impressions, providing invaluable analytical information for merchants.

Importantly, for analytics purposes, the present invention augments the gaps in a pathway taken by a shopper reported by indoor positioning data with routes determined from point of sale (POS) transaction data for the relevant shopper.

POS transaction data contains information regarding each customer transaction, e.g., which items were purchased, how many of each item were purchased, what the cost was, the date and time of purchase, etc. Additional POS transaction information may include an identify of the specific POS terminal that handled the purchase, and a frequent buyer account identity. The frequent buyer account identity can be used, in accordance with the principles of the present invention, to tie together separate trips to a given store for a given frequent buyer such that POS transaction data can be combined to identify associations generated between separate shopping trips to the store. For instance, a customer may walk past an item on a first shopping trip, then return three days later to purchase that item.

Routes that a particular customer takes on their shopping journey that are not reported using indoor positioning in a given store are then determined using routing between subsequently reported location points.

If not included in an LDR, a starting point for the customer's journey is chosen. For instance, the starting point may be set at a “default” entrance for the given venue/store.

Then, for gaps between reported locations as indicated by location detail records (LDRs), a presumed route taken by the customer may be generated as the shortest path between the nodes. In accordance with the invention, if point of sale (POS) transaction data indicates a purchased item lies along a gap in the indoor positioning data, then a route will be generated that includes a dwell at the location of the purchased item.

Moreover, if not reported by indoor positioning data as indicated by an appropriate location detail record (LDR), a default checkout POS terminal will be included as a node, and a route from the last LDR or closest item purchased will be added to the shopper's pathway through the store. Otherwise conventional route logic between the nodes is implemented to generate the customer's presumed route through the store based on the items that they purchased on any given shopping trip.

### (2) Blue Dot “Heatmap” Depicting Aggregate Activity of a Plurality of Shoppers Over a Selected Time Window or Windows Over a Given Number of Days

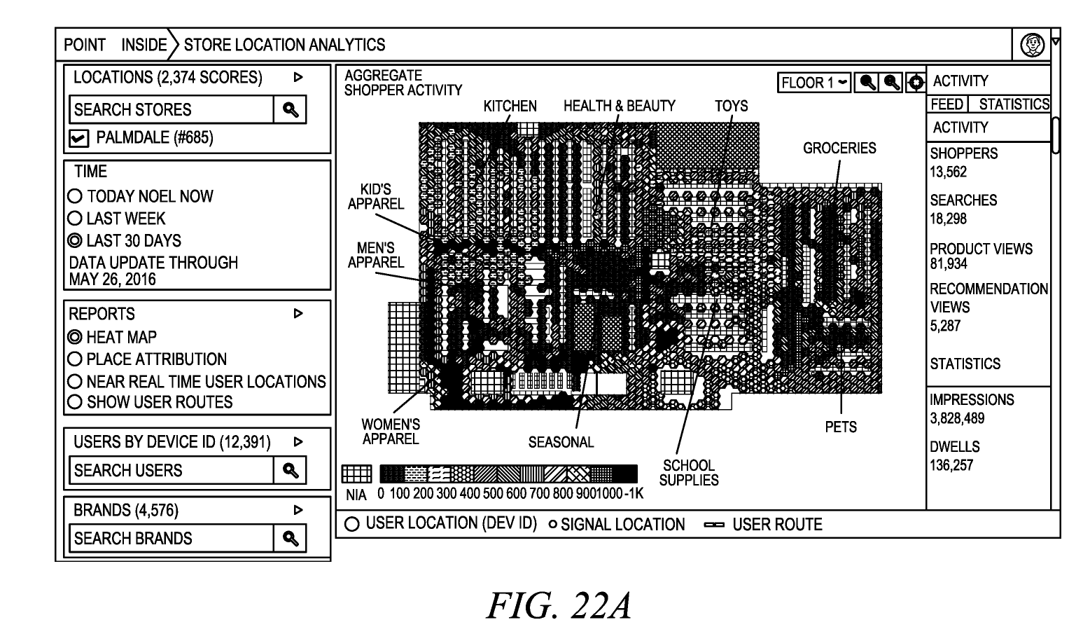

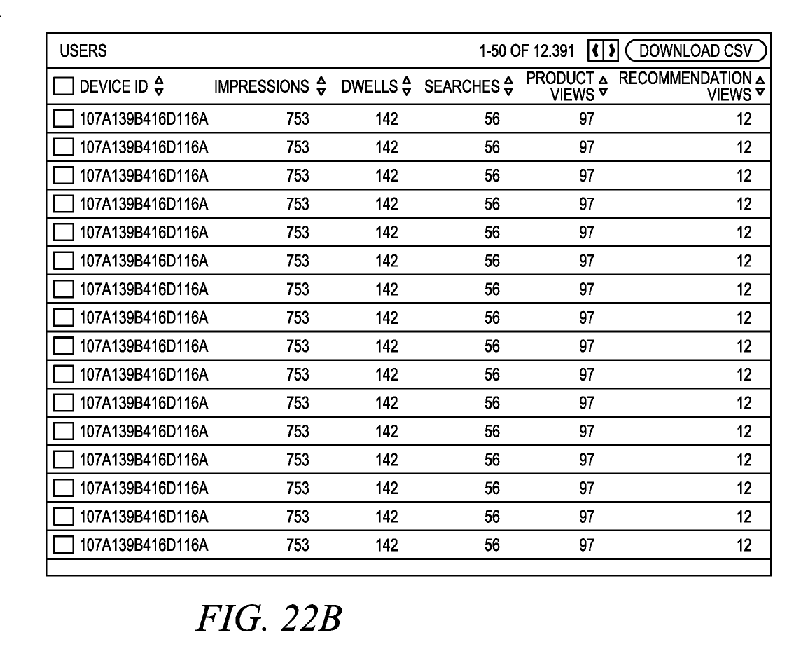

FIGS. 22A and 22B show a heat map view of an aggregate of shoppers over a selected period of time through the given store.

In particular, as shown in FIGS. 22A and 22B, extrapolating shopper paths based on indoor positioning information over a given period of time, e.g., over the past 30 days, provides a heat map of the routes taken by shoppers, and dwell patterns of the shoppers, as well as the number of product impressions, recommendation views, and generally where shoppers are spending their time while in the store.

In the shown heat maps, the darkness of the spot is shown relative to the number of dwells. A mapping of the spot darkness to the range of dwells is ideally normalized based on a highest number of dwells, although the invention does not require normalization.

While the heat map is shown with a darkness of spots indicating a number of dwells, other methods of showing a density at each location within the store may be implemented within the principles of the present invention. For instance, a three-dimensional map may be generated with a z-axis, or height, of each spot indicating a number of dwells.

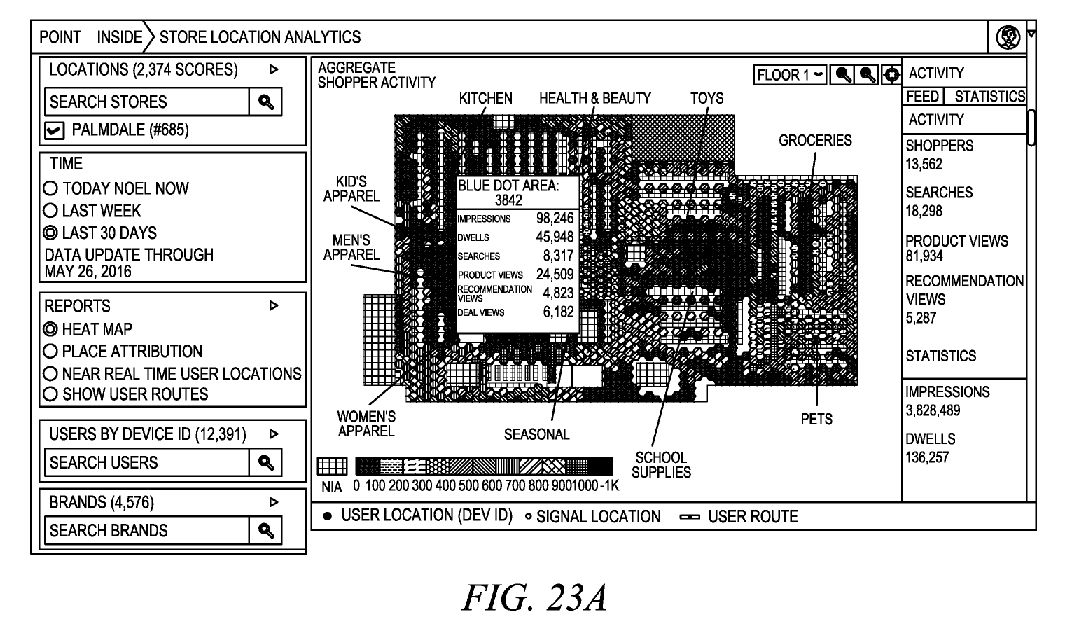

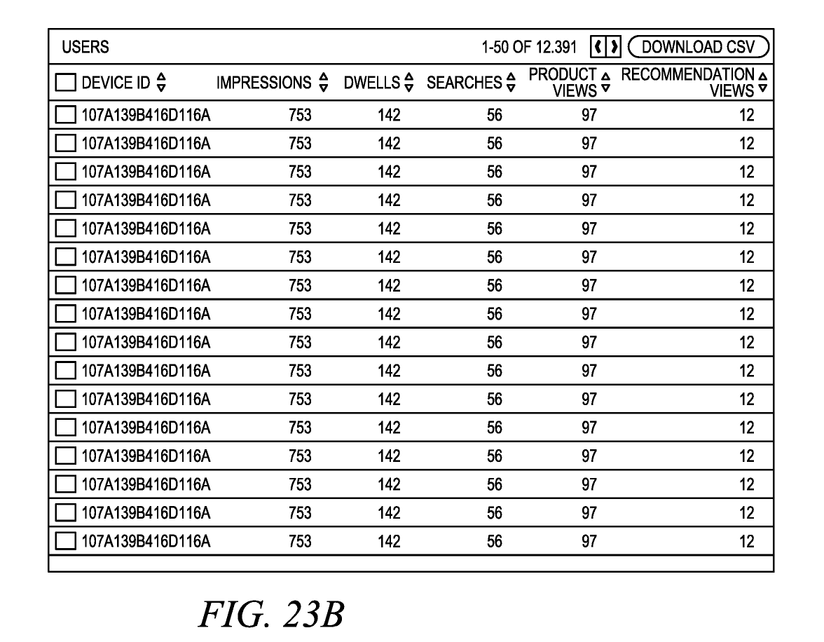

FIGS. 23A and 23B show a heat map and exemplary impressions statistics for an aggregate of shoppers at a given store over a selected period of time.

In particular, as shown in FIGS. 23A and 23B, relevant statistics can be generated by the single trip of the given shopper, including determination of how effective the recommendations were (e.g., whether or not the given shopper purchased a recommended item). Impressions of other products the given shopper experienced may also be determined.

### (3) Brand Affinity Analysis

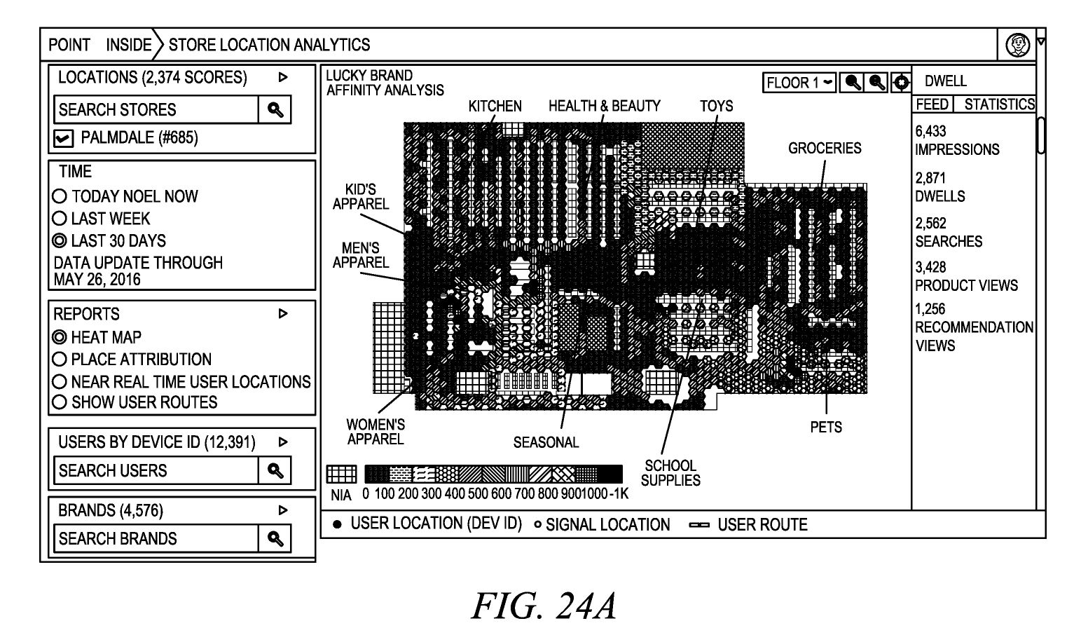

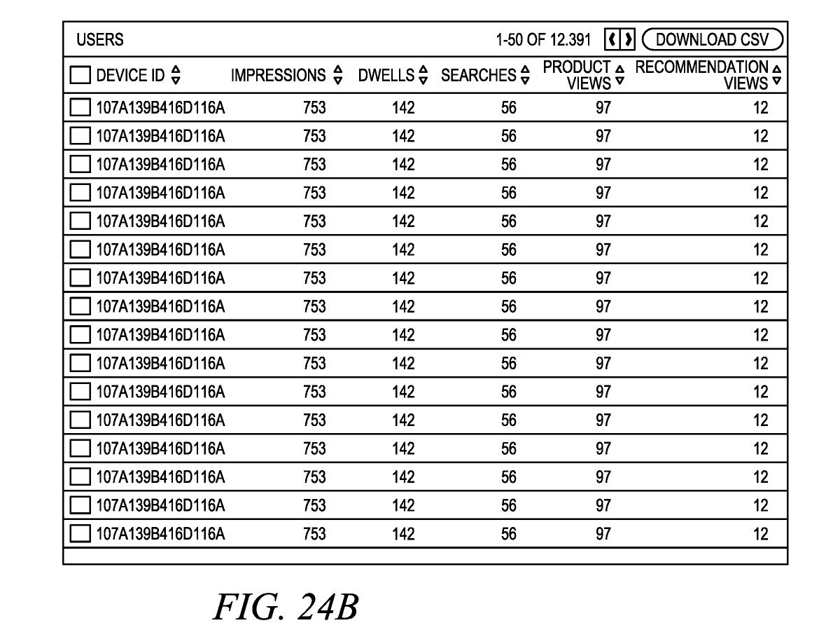

FIGS. 24A and 24B show a heat map of a brand affinity analysis, in accordance with the principles of the present invention.

In particular, as shown in FIGS. 24A and 24B, a particular brand jeans is selected for heat map generation, and the generated heat map shows what other items that shoppers during the selected time period (e.g., the past 30 days) viewed along with their purchase of the particular brand jeans.

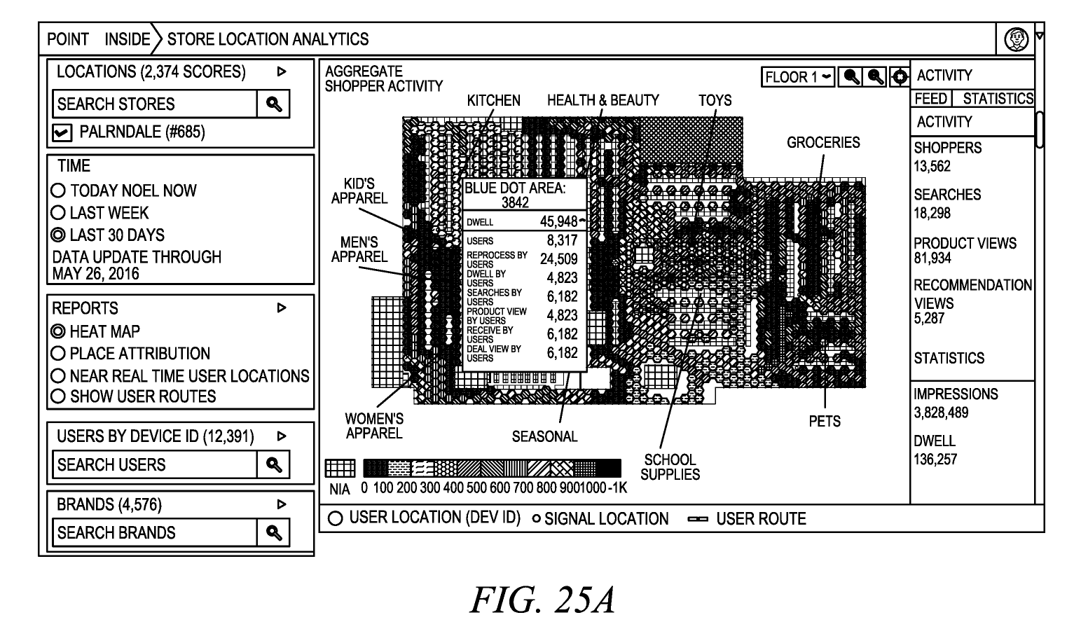

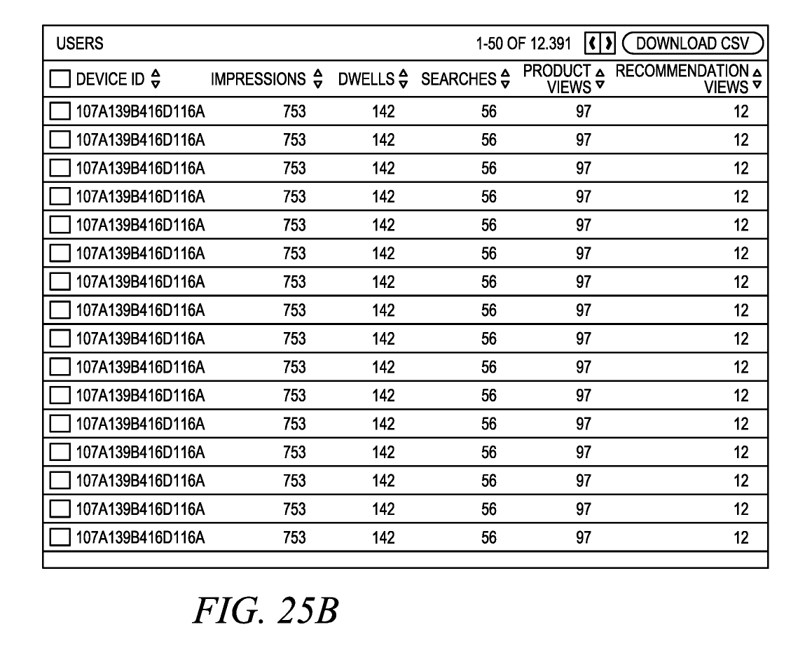

FIGS. 25A and 25B show a heat map and exemplary dwell statistics for aggregated shopper activity at a given store within a selected period of time.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

Unless the context clearly requires otherwise, throughout the description and the claims, references are made herein to routines, subroutines, and modules. Generally it should be understood that a routine is a software program executed by computer hardware and that a subroutine is a software program executed within another routine. However, routines discussed herein may be executed within another routine and subroutines may be executed independently, i.e., routines may be subroutines and vice versa. As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs or routines having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module, or be split among several modules. The components may be processes running on, or implemented on, a single computer, processor or controller node or distributed among a plurality of computer, processor or controller nodes running in parallel, concurrently, sequentially or a combination.

While the invention has been described with reference to the exemplary embodiments thereof, those skilled in the art will be able to make various modifications to the described embodiments of the invention without departing from the true spirit and scope of the invention.

What is claimed is:

1. A method of generating item location based shopper impressions based on indoor positioning data of a shopper's location in a store, the method comprising:
associating a physical location, within a given store, to a plurality of items available at the given store;
obtaining a plurality of sets of location detail records (LDRs), each relating to one of a plurality of shoppers at the given store within a given time frame;
filtering the plurality of sets of location detail records (LDRs) to those filtered LDR sets including at least one LDR associated with an item available at the given store having a given attribute;
plotting a pathway of physical journey through the given store as indicated by a selected one of the filtered LDR set representing one shopper; and
appending to the pathway of physical journey a route calculated between an item purchased by the one shopper but not included in the selected filtered LDR set, and a nearest node on the pathway of physical journey.

2. The method of generating item location based shopper impressions based on indoor positioning data of a shopper's location in a store according to claim 1, wherein:
the plurality of sets of location detail records are obtained from physical mobile devices respectively associated with each of the plurality of shoppers.

3. The method of generating item location based shopper impressions based on indoor positioning data of a shopper's location in a store according to claim 1, wherein:
the physical location of the plurality of items is obtained based on (POS) transaction data for the store.

4. The method of generating item location based shopper impressions based on indoor positioning data of a shopper's location in a store according to claim 1, wherein the attribute comprises:
a brand of the item.

5. The method of generating item location based shopper impressions based on indoor positioning data of a shopper's location in a store according to claim 1, wherein the attribute comprises:
an identity of the item.

6. The method of generating item location based shopper impressions based on indoor positioning data of a shopper's location in a store according to claim 1, wherein the attribute comprises:
a category of the item.

7. The method of generating item location based shopper impressions based on indoor positioning data of a shopper's location in a store according to claim 1, wherein the attribute comprises:
a department of the item.

8. The method of generating item location based shopper impressions based on indoor positioning data of a shopper's location in a store according to claim 1, further comprising:
obtaining a location of all items in the given store.

9. A method of generating item location based shopper dwell based on indoor positioning data of a shopper's location in a store, the method comprising:
associating a physical location, within a given store, to a plurality of items available at the given store;
obtaining a plurality of sets of location detail records (LDRs), each relating to one of a plurality of shoppers at the given store within a given time frame;
filtering the plurality of sets of location detail records (LDRs) into a logical row or column of filtered LDR sets including at least one LDR associated with an item available at the given store having a given attribute;
determining a plurality of dwell locations associated with each of the filtered LDR sets; and
visually outputting the determined plurality of dwell locations corresponding to an aggregate of a plurality of shoppers associated with the filtered LDR sets on their physical travel through the given store.

10. The method of generating item location based shopper dwell based on indoor positioning data of a shopper's location in a store according to claim 9, wherein:
the visually outputting the determined plurality of dwell locations comprises generation of a heat map.

11. The method of generating item location based shopper dwell based on indoor positioning data of a shopper's location in a store according to claim 9, wherein:
the plurality of sets of location detail records are obtained from physical mobile devices respectively associated with each of the plurality of shoppers.

12. The method of generating item location based shopper dwell based on indoor positioning data of a shopper's location in a store according to claim 9, wherein:
the physical location of the plurality of items is obtained based on (POS) transaction data for the store.

13. The method of generating item location based shopper dwell based on indoor positioning data of a shopper's location in a store according to claim 9, wherein the attribute comprises:
a brand of the item.

14. The method of generating item location based shopper dwell based on indoor positioning data of a shopper's location in a store according to claim 9, wherein the attribute comprises:
an identity of the item.

15. The method of generating item location based shopper dwell based on indoor positioning data of a shopper's location in a store according to claim 9, wherein the attribute comprises:
a category of the item.

16. The method of generating item location based shopper dwell based on indoor positioning data of a shopper's location in a store according to claim 9, wherein the attribute comprises:
a department of the item.

17. The method of generating item location based shopper dwell based on indoor positioning data of a shopper's location in a store according to claim 9, further comprising:
obtaining a location of all items in the given store.

18. A non-transient computer-readable storage medium having stored thereon instructions that, when executed on a processor, configure the processor to generate item location based shopper dwell based on indoor positioning data of a shopper's location in a store, by:
associating a physical location, within a given store, to a plurality of items available at the given store;
obtaining a plurality of sets of location detail records (LDRs), each relating to one of a plurality of shoppers at the given store within a given time frame;
filtering the plurality of sets of location detail records (LDRs) into a logical row or column of filtered LDR sets including at least one LDR associated with an item available at the given store having a given attribute;
determining a plurality of dwell locations associated with each of the filtered LDR sets; and
visually outputting the determined plurality of dwell locations corresponding to an aggregate of a plurality of shoppers associated with the filtered LDR sets on their physical travel through the given store.
